(19) United States
(12) Patent Application Publication
(10) Pub. No.: US 2021/0056580 A1
(43) Pub. Date: Feb. 25, 2021

(54) SYSTEMS AND METHODS FOR DIGITAL RETAIL OFFERS

(71) Applicant: Jay S. Walker, Stamford, CT (US)

(72) Inventor: Jay S. Walker, Stamford, CT (US)

(21) Appl. No.: 17/033,848

(22) Filed: Sep. 27, 2020

Related U.S. Application Data
(63) Continuation of application No. PCT/US2019/024711, filed on Mar. 28, 2019.
(60) Provisional application No. 62/649,056, filed on Mar. 28, 2018.

(51) Int. Cl. G06Q 30/02; G06Q 20/32; G06Q 30/06; G06Q 20/20; G06T 11/00; G06K 9/00

(52) U.S. Cl. CPC G06Q 30/0234; G06Q 20/326; G06Q 20/3224; G06Q 30/0623; G06Q 30/0643; G06Q 30/0222; G06T 2200/24; G06Q 20/202; G06Q 30/0215; G06Q 20/209; G06T 11/00; G06K 9/00671; G06Q 30/0238

(57) ABSTRACT

Provided herein are methods and systems for outputting to a customer physically located in a brick-and-mortar retail establishment a plurality of personalized digital retail offers. In accordance with some embodiments, the customer may capture an image of a plurality of products using his mobile device and upload it to a Personal Digital Retail Offer System. The System may analyze the image to identify at least one product and, using customer profile information, modify the image using Augmented Reality technology to superimpose at least one image graphic onto the image, the image graphic defining a digital retail offer for that product. At the end of the customer's shopping visit, the system may reconcile the digital retail offers output to the customer during the visit against the products in the customer's transaction and provide to the customer any benefits defined by offers corresponding to such products.

### CLAIM OF PRIORITY

The present application is a Continuation Application of PCT Application No. PCT/US2019/024711, filed on Mar. 28, 2019 in the name of Jay S. Walker and titled SYSTEMS AND METHODS FOR DIGITAL RETAIL OFFERS, which PCT Application claims the benefit of U.S. Provisional Application No. 62/649,056 filed on Mar. 28, 2018 in the name of Jay S. Walker and titled SYSTEMS AND METHODS FOR DIGITAL RETAIL OFFERS. The entirety of each of these applications is incorporated by reference herein for all purposes.

### BACKGROUND

As technology advances and the online retail experience becomes better and better for customers and for retailers, brick-and-mortar retailers have to innovate in order to stay relevant. Today's online shopping experience gives customers a number of advantages over the experience in a brick-and-mortar store: online customers can compare prices against other online retailers with a few clicks; they can check reviews from multiple locations; and they can check for online discounts and coupons from many sources. And since an online account may be associated with each purchase, an online retailer can tailor the products and prices offered to the customers' history. Many of these benefits aren't easily available in the current brick-and-mortar shopping experience.

Brick-and-mortar retailers are typically working with a partial understanding, at best, of the customers that shop in their stores. Conversely, online retailers benefit from a fuller, more consistent relationship with their customers, but even the online retailer's data falls short and does not capture data that might be helpful in assessing a customer's inclinations or indicate how persuadable a customer may be in terms of product offers and discounts. Improvements can be made to a brick-and-mortar shopping experience that enhances the experience of the customer and allows retailers, manufacturers and other entities to more effectively tailor marketing offers for such customers.

### SUMMARY

Applicant has recognized that combining more comprehensive information about customers that is not readily available to, or used by, brick-and-mortar retailers for customers physically present in a brick-and-mortar retailer with technology that is not practically deployable for online retailers, improvements to the brick-and-mortar shopping experience can be made such that product vendors, manufacturers, and/or retailers may be able to better customize and target their marketing efforts and customers can experience a more entertaining and fun shopping experience that also results in cost savings. Applicant has further recognized that if a consistent or relatively reliable communication connection with the brick-and-mortar customer were available, while the customer is shopping at a physical brick-and-mortar store, then these entities would possibly be able to more successfully target customers on an individual basis. Less money would be spent on blanket marketing campaigns that extend to unqualified, uninterested customers. Concurrently, customers would be more likely to get better prices while having more fun during their shopping experience, retailers would be more like to get better (e.g., larger or more valuable) sales, and product vendors would be more likely to sell more products or products that result in a higher profit.

Accordingly, various embodiments described herein provide for systems and methods via which a customer physically present in a brick-and-mortar retail establishment may be provided with real-time offers via a customer device (e.g., a mobile phone) using technology such as augmented reality (AR) in order to serve offers to the customers based on customization data related to the customer. In accordance with some embodiments, such offers may be output to customers by superimposing an offer graphic onto an image of at least one product available to the customer in the retail establishment, such as an image captured by the customer using his mobile device. The offer graphic may be superimposed or otherwise applied to the image captured by the customer in order to enhance the image using technology. In some cases, for example, an image of one or more products captured and displayed by mobile devices may be augmented to overlay virtual representations comprising offer graphics into what otherwise appears to be an image of the physical world in which the mobile device operates. In accordance with some embodiments, multiple offers may be output to a customer using such technology while the customer is shopping in the retail establishment.

In accordance with some embodiments, offers output to the customer during a particular shopping event or visit may be tracked. Upon checkout (or, in some embodiments, after checkout) of the retail establishment, the system may compare the items the customer is purchasing in a current transaction to the offers that had been output to the customer during the current shopping visit and apply any discounts or other benefits defined by such offers for items being purchased in the transaction.

### BRIEF DESCRIPTION OF THE FIGURES

FIG. 1A is a block diagram of an example architecture of a system consistent with at least some embodiments.

FIG. 1B is a block diagram of an example server consistent with at least some embodiments.

FIG. 2 is an example of a GUI that may be output to a customer in accordance with some embodiments.

FIGS. 3A and 3B comprise examples of respective GUIs that may be output to a customer via a customer device, in accordance with some embodiments.

FIGS. 4A and 4B comprise examples of respective GUIs that may be output to a customer via a customer device, in accordance with some embodiments.

FIG. 5A comprise an example image that may be captured by customer's device, shown without augmented reality implementation of digital retail offers, in accordance with some embodiments.

FIG. 5B comprises the example image of FIG. 5A but shown with augmented reality implementation of digital retail offers, in accordance with some embodiments.

FIG. 6A comprise an example image that may be captured by customer's device, shown without augmented reality implementation of digital retail offers, in accordance with some embodiments.

FIG. 6B comprises the example image of FIG. 6A but shown with augmented reality implementation of digital retail offers, in accordance with some embodiments.

FIG. 7A comprise an example image that may be captured by customer's device, shown without augmented reality implementation of digital retail offers, in accordance with some embodiments.

FIG. 7B comprises the example image of FIG. 7A but shown with augmented reality implementation of digital retail offers, in accordance with some embodiments.

FIG. 8 comprise an example flowchart illustrating one example process consistent with at least some embodiments described herein.

### DETAILED DESCRIPTION OF EMBODIMENTS

Described herein are systems, methods, graphical user interfaces (GUIs) and articles of manufacture for a Personalized Digital Retail Offer System and application (e.g., mobile device application) that enables product vendors, retail establishments, and/or other entities to create digital retail offers that get presented to customers who are making purchase decisions in a physical brick-and-mortar store.

In accordance with some embodiments, customers use an electronic device to connect to the Personalized Digital Retail Offer System (PDRO System) while they shop at a brick-and-mortar retail establishment. For purposes of brevity, a brick-and-mortar retail location or store is referred to as a “retail establishment” herein while an online retail location or virtual store is referred to as an “online retail portal”. At one or more points of the shopping experience, the PDRO System may present the customer with information about, and/or digital retail offers for, products offered for sale by the retail establishment (it should be noted that the term “product” as used herein may refer to a physical product, a digital product or a service, as offered for sale at a retail establishment or online retail portal). For example, customers may be offered discounted prices on specific products, package pricing for combinations of products, rebates or other types of rewards. As customers make purchases, the system tracks the offers that were output to the customer during their current shopping experience and applies them during the check out process. In some embodiments, the PDRO System may further be operable to reconcile fulfillment of the offers that are used or accepted by a customer (e.g., at checkout or another time). In accordance with some embodiments, the system may reconcile fulfillment of offers either through cooperation with the retail establishment or via an independent reconciliation process within the system. It should be noted that when functionality is described herein as being performed by the PDRO System, it may refer to such functionality being performed by an entity managing the operations of the PDRO System and/or a specific device (e.g., one or more servers operated by or on behalf of an entity managing the operations of the PDRO System).

In accordance with some embodiments, the information and offers that each customer receives while using the PDRO System may be unique to each individual customer. In other words, the information and offers are considered “personalized” because during a given shopping experience or visit, the PDRO System may present Customer A with an entirely different set of offers than it presents to Customer B. In other embodiments, although offers may be personalized for customers (e.g., based on various data such as purchase history, demographics, store inventory, customer location, items in the customer's basket), offers may not necessarily be unique (e.g., different customers who share some characteristics or data may receive the same or similar offers).

In accordance with some embodiments, digital retail offers made to customers can be personalized because the system references one or more datasets, including purchase history data—for example, the data that retail establishments collect and store via electronic Point-of-Sale (POS) and customer loyalty systems—and customer profile data. Customer profile data, as described herein, may include the customer's specific purchase history, demographic information about the customer, shared 3rd party account information, previous digital offers presented and their success rates, and/or information about other “like” customers in the system (e.g., customers of a particular cohort or customers who share one or more characteristics).

The analysis of these datasets may be performed using, for example, machine learning and artificial intelligence software. In some embodiments, continuous collection of new data may also be utilized, such that the PDRO System can target offers and information that are particularly relevant and useful for the customer. Over time, the system can “learn” and improve the types of offers that customers receive, in order to maximize the benefit to customers, and to maximize the purchases made in a retail establishment. One example method that may be implemented for use by the PDRO system in some embodiments provides for building profiles of individual customers and groups of similar customers, and identifying trends, and changes in trends, within the profile data. Another example method that may be implemented for use by the PDRO System in some embodiments may provide for making time-based value evaluations of each customer, or of customers in a cohort (e.g., customers who are associated with one or more specific characteristics). For example, the system may be operable to begin to predict a time-based value for customers: the amount of money a customer is “worth” to a retailer, product, brand, etc. over a specified amount of time (i.e., a month, season, year, life-stage or a lifetime).

Time-based value evaluation and profiling of customers may also be useful to participating retail establishments, product manufacturers and distributors, and/or many other entities. By contributing data to the system, such entities may benefit from a resource that “connects the dots” between the data sets, and provides a much fuller picture of their targeted customers. It is envisioned that once a system consistent with at least some embodiments described herein is available, any of a number of parties may be interested in participating by submitting digital retail offers that influence and subsidize customers' purchasing decisions. For example, the manufacturer of soap may want to directly offer discounts to highly qualified customers who are modeled to have a large time-based value. In another example, the manufacturer of diapers may want to capture the early purchases of new fathers by heavily subsidizing their product vs competitors'. Entities that create, develop, fund and/or submit digital retail offers that are to be output to customers by the PDRO System are referred to herein as “offering entities”.

In accordance with some embodiments, digital retail offers may be made by an offering entity that is closely involved with transactions in a retail establishment, such as the retail establishment itself, or a product vendor, or a manufacturer of a product. In another example, digital retail offers may be made by an offering entity that is not closely involved with the transaction, but who may nonetheless have a reason to make digital retail offers, such as the customer's employer; a health insurance or health care provider, relatives of the customer, charities and philanthropies, government agencies, local businesses, etc.

In order to determine when to display digital retail offers, the PDRO System may request from an offering entity submitting a digital retail offer to the PDRO System a selection or definition of one or more rules that governs to whom, when, where and for what products the digital retail offers are made. Offering entities may define various conditions or rules that govern the output of the digital retail offers they want to make, such as the types of customer they want to target, the types of products they want to promote, the details of the offer they want to make, etc. Using these rules and customer profiling the PDRO configures and presents customers with digital retail offers (and, in some embodiments, fulfils the offers), on behalf of the offering entities.

In accordance with some embodiments, some example benefit of the systems and methods described herein include: (i) customers may benefit from spending less money on the products they want; (ii) vendors and other offering entities may benefit from capturing new customers and increasing sales; and (iii) retail establishments may benefit from increased customer sales and traffic by providing a better, more modern shopping experience.

The term “retail establishment”, unless indicated otherwise herein, refers to a brick-and-mortar business that makes products available for sale to customers. This may include retailers with single stores or multiple locations, such as chain or big-box stores. Retailer establishments may include business that have mobile or temporary locations. In some embodiments, a single entity may operate both a retail establishment and an online retail portal.

The term “product vendor”, unless indicated otherwise herein, refers to a supplier, distributor or manufacturer of products that are sold by a retail establishment.

The term “offering entity”, unless indicated otherwise herein, refers to an entity with an interest in making an offer to a customer about a product for sale in a retail establishment. For example, the entity might offer to subsidize the customer's purchase, resulting in a discount. Examples of other parties who may want to provide reduced or promotional prices include: (i) relatives of the customer; (ii) caregivers of the customer; (iii) a healthcare provider; (iv) an environmental activist organization; and (v) product advocates.

The term “customer”, unless indicated otherwise herein, refers to a consumer of products, specifically a purchaser of products from a retail establishment.

The term “digital retail offer”, unless indicated otherwise herein, refers to an offer presented to a customer that defines a benefit to be provided to a customer (above and beyond the customer's enjoyment of the product and in addition to any benefits that the customer may realize if (s)he were to purchase the product without accepting the offer) to be provided to a customer who purchases a product in accordance with the one or more conditions associated with the offer (e.g., the product must be purchased on the day the offer is made, before the customer leaves the retail establishment and/or as part of a combination of a plurality of products). In accordance with some embodiments, a benefit may comprise a reduced or promotional price for the one or more products defined by the offer, a discount, a rebate for a product, an extra unit of the product (or a unit of a different product) for a discounted price, a service or anything else of value to the customer.

A digital retail offer may be made by any offering entity, such as the retail establishment, the vendors of products that appear in a retail establishment, or any other party interested in providing reduced or promotional prices in order to influence the consumer's purchase. In accordance with some embodiments, a digital retail offer may require the customer to satisfy a condition in order to receive the benefit defined by the offer (such an offer comprising an offer with conditional requirements) while in other embodiments a digital retail offer may provide for the defined discount or promotional price defined by the offer to be made immediately available to the customer upon purchase of the product by the customer.

Examples of conditional requirements may include: providing responses to polls, watching an ad, sharing an ad with friends, posting about the product on social media, making multiple purchases of the product, purchasing another product in combination, etc.

Offers are described as “digital” because they are designed to be delivered by digital means to customers of a retail establishment. For example, customers may receive these offers via an electronic device operatively connected to or in communication with the PDRO System. As described herein, a customer devices may include any personal computing device, such as mobile phone, a smartphone, a tablet, a personal computer, a smart watch, smart glasses, wearable computers, fitness trackers, etc. Examples of digital delivery include, without limitation, the following: (i) AR graphics layered onto images captured by a customer device; (ii) text based messages; (iii) audio tones or recorded messages; (iv) videos or animations; (vi) AR or Virtual Reality (VR) virtual reality animations and/or graphics; (v) tactile indications.

The term “Personalized Digital Retail Offer System” or “PDROS”, as used herein unless indicated otherwise, may refer to a a system and application that enables an entity to provide a digital retail offer to a customer shopping in a retail establishment.

The term “offer rules”, as used herein unless indicated otherwise, refers to a set of criteria that are evaluated by the PDRO System and used to determine when (e.g., under what circumstances) to present an offer to a customer of a retail establishment. These rules may be set by a product vendor, by the retail establishment, or another party interested in providing an offer to a customer of a retail establishment.

The term “Point of Sale” or “POS”, as used herein unless indicated otherwise, refers to a system of hardware and software via which a customer may obtain ownership of a product by providing payment therefore. A POS may be stationary (e.g., such as a POS comprising a cash register at the checkout are of a store) or mobile (e.g., such as a POS comprising an iPAD™ or other mobile device equipped with payment receiving means such as a Square™ payment component). In some embodiments a POS may be equipped with a scanning device for scanning a Universal Product Code (UPC) identifier of a product, usable to read the bar code component of the UPC and identify the retail price to the customer and the cashier and, in accordance with some embodiments described herein, any digital retail offers that had been output to the customer for a particular product during a current shopping event. In some embodiments, a POS may comprise a self-contained system within a check-out area of a retail establishment while in other embodiments a POS may be part of a local network or operable to access a remote database for matching UPC, price and digital retail offers that were output to a customer.

The terms “purchase history data” and “TLog Data” are used interchangeably herein and, unless indicated otherwise, refer to data collected and stored about transactions that occur at a retail establishment. For example, this may be any information stored in databases maintained by retail establishments about historical purchases made in the store. This includes what the retail industry refers to as POSLogs, TLogs, EDI data, and the like. This also includes any customer loyalty program data that may be maintained by a retail establishment or a third party.

The term “product identifier”, as used herein unless indicated otherwise, refers to any identifying information that can be used by a machine to identify a product, such as; a Stock Keeping Unit (SKU); a Universal Product Code (UPC); a brand logo; a serial or model number; a Radio Frequency Identification Tag (RFID Tag); a Quick Response Code (QR); a proprietary code; Packaging shape, design, or graphic; a product location.

The term “customer profile information”, as used herein unless indicated otherwise, refers to profile information about individual customers and cohorts of customers that participate in receiving an offer from the PDRO System, as stored and maintained by the PDRO System. Profiling customers is described extensively herein but may be understood to include (i) data directly related to a customer, and assumptions based on an analysis of the customer's data; and/or (ii) data related to similar customers.

In accordance with some embodiments, data directly related to a customer may include, but is not limited to: information from multiple sources of data, such as retail establishment purchase history, shared accounts like social media accounts or online retailer accounts, customer's account and activity within the PDRO System, demographic information collected about the customer, etc. In accordance with some embodiments, by analyzing data such as the foregoing, assumptions may be drawn, or inferences made, and stored in the customer's profile. For example, trends observed in aggregate analysis of similar customers (e.g., customers who share one or more characteristics) may also be applied to a customer's profile. Some examples of assumptions or inferences may include, but are not limited to: A customer's location based on where and when he/she shops; whether or not he/she has kids, based on the types of products purchased (like toys); health conditions based on OTC medicines or prescriptions purchased; dietary preferences of the customer (e.g., organic foods, low fat foods, inexpensive foods), etc.

The term “time-based value”, as used herein unless indicated otherwise, refers to a value (e.g., a monetary value) assigned to a customer by the PDRO System as a representation or indication of a particular customer's value to a particular offering entity. For example, through analysis of customers' profile information and observation of purchasing trends, the system can make time-based value predictions about customers. For example, a new parent who purchases formula for a child, may have a value of $x per child she/he is known to have, as determined by the average amount parents spend on formula. In some embodiments, values can be determined broadly (i.e., on average, all parents spend this much on formula) and/or can be refined by closer analysis of profile data (i.e., on average, parents in City A spend this much on formula, and parents in City B spend this much on formula). As the system learns more and more about its customers, and by virtue of working with large amounts of data, the system may be able to make very specific value assumptions (i.e., on average, parents in City A, who spend SA/month on groceries, and who also shop X/year at Saks 5th Avenue, who have >2 children, and who buy diet soft drinks, tend to spend $Y on baby formula).

The term “machine learning”, as used herein unless indicated otherwise, refers to software and/or an algorithm utilized by a computing device to adapt, evolve or learn without being explicitly programmed to do so, which may include algorithms that can learn from and make data driven predictions or decisions through building a model based on sample inputs.

The term “customer device”, as used herein unless indicated otherwise, refers to a customer's electronic computing device operable to receive input from a customer (e.g., a request to review one or more digital retail offers) and output data to the customer (e.g., GUI that indicates one or more digital retail offers available to the customer), which computing device may be operable to wirelessly communicate with the PDRO System or a component thereof. Examples of customer devices that may be useful in at least some embodiments described herein include mobile devices such as a cell phone or smart phone, a tablet, personal computer, wearable device such as a fitness tracker, smart watch, smart glasses, virtual reality headset, etc. The customer may use this device to access the personalized digital retail offer system.

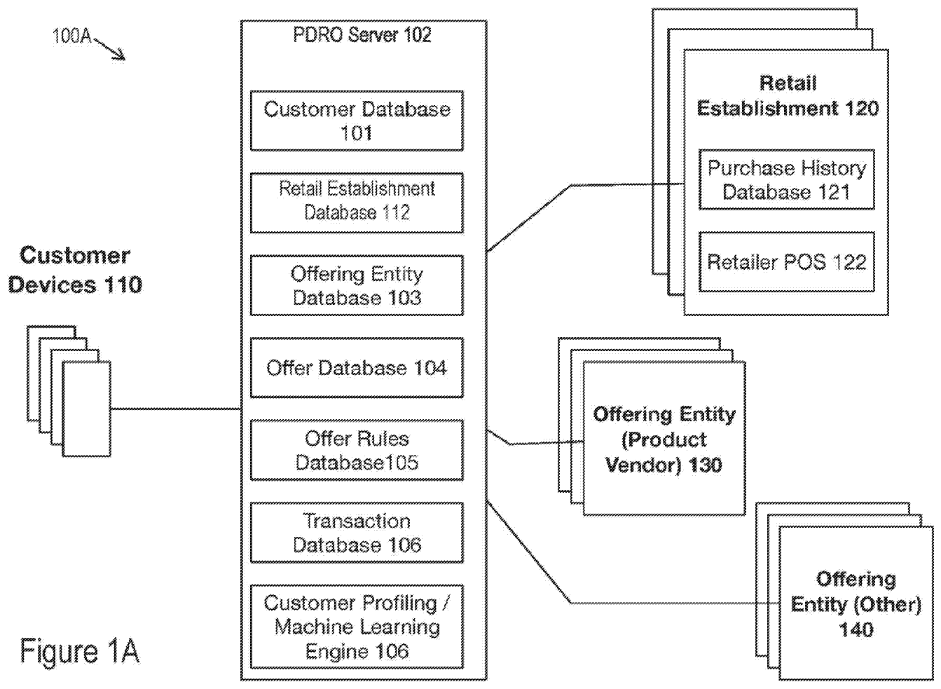

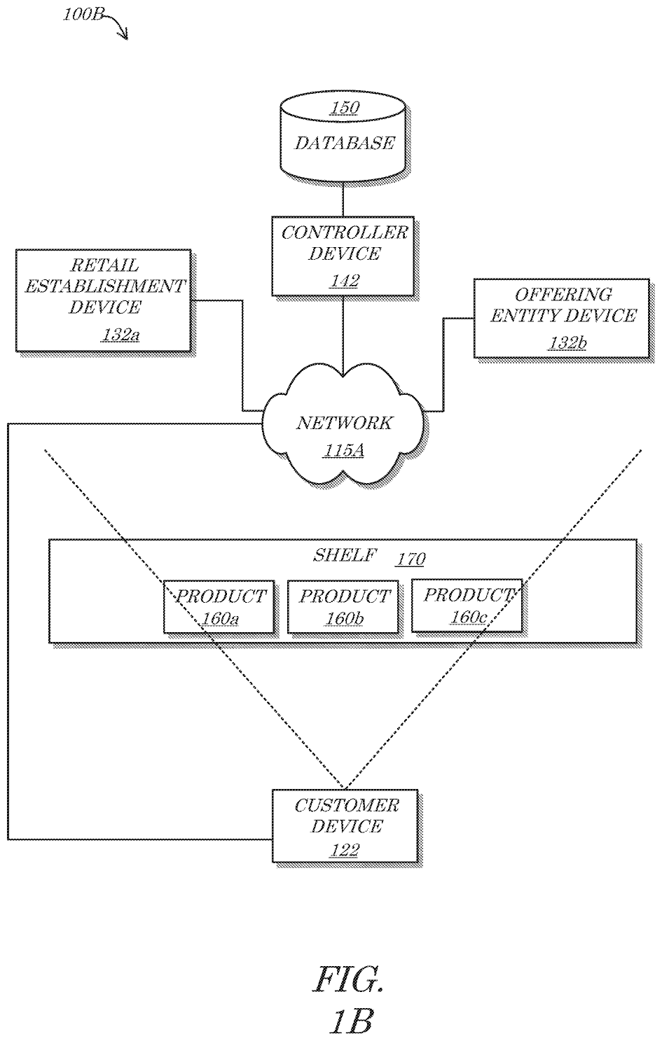

Referring now to FIG. 1A, illustrated therein is a schematic diagram of an example system 100A that may be utilized to implement some of the embodiments described herein. In accordance with some embodiments, there are three basic types of entities involved in presenting digital retail offers to customers of retail establishments while the customers are at the retail establishments, and applying any of such output offers to a transaction as the customer is checking out of the retail, based on the items the customer is purchasing. In accordance with some embodiments, such entities may comprise customers, retail establishments, and offering entities. FIG. 1A demonstrates one possible arrangement in which a system involving these three entities may be configured in order to achieve at least some of the features and embodiments described herein.

The System 100A may, in accordance with some embodiments, be controlled or facilitated by servers, software and hardware comprising a PDRO Server 102, which may comprise one or more servers. The PDRO Server 102 may be operable to communicate, via a wired or wireless connection and/or over network 115A (not shown, but which is represented by the lines connecting the various components of system 100A), with (i) a plurality of customer devices 110; (ii) at least one retail establishment server 120; and (ii) a plurality of offer providing entity servers which, in accordance with some embodiments, may comprise servers of product vendors (130) and/or servers of other types of offering entities (14). The PDRO Server 102 may store one or more database or other data storing schemes comprising data utilized by the PDRO Server 102 to provide the customer services and features, in accordance with embodiments described herein. For example, account access credentials and customer profile information may, in some embodiments, be stored within (or otherwise accessible to) PDRO Server 102 (e.g., using Customer Database 101). For example, as described herein, a customer who would like to see digital retail offers for products output to him/her via a customer device from the PDRO system may download its software app onto his/her customer device (and, in some embodiments, register with the PDRO system). In registering with the PDRO system and downloading the PDRO app, the consumer may, in at least some embodiments, be asked to provide information that may help the system target digital retail offers that may be of particular interest to the customer (e.g., demographic information and preferences). Such information may be stored in association with the customer's account with the PDRO system.

As described above, a customer devices 110 may comprise any number of portable computing devices that are operable to present the customer with digital retail offers. For example, a customer device may comprise a mobile phone, a smartphone, a tablet, a personal computer, a smart watch, smart glasses, wearable computers, fitness trackers, etc. While shopping at a retail establishment, customers may choose to access the PDRO System via their customer device in order to take advantage of digital retail offers for products offered at the retail establishment. While in some embodiments a customer device may comprise a personal device of a customer, in other embodiments a customer device may comprise a dedicated device provided to the customer by the retail establishment for purposes of accessing the PDRO System.

A server of an offering entity such as a server 130 and/or a server 140 may comprise one or more servers. In one embodiment, an offering entity operating one or more of the servers 130 or 140, or an entity operating retail establishment server 120, may comprise the entity operating the PDRO System 100A and thus there may not be a need for the system 100A to include multiple offering entity servers or both a PDRO server 102 and a retail establishment server 120. For example, the PDRO Server 102 may store some or all of the data described herein as being stored in (or perform some of the functionality described as being performed by) the retail establishment server 120, an offering entity server 130 and/or offering entity server 140.

In accordance with some embodiments, the retail establishment server 120 may provide access to data, such as may be stored in Purchase History Database 121 and/or Retailer POS 122. This or another system design may provide to the PDRO Server 102 access to a retail establishment's transaction history information. This information may be accessed as needed, or copies of such information (or a subset or variation of such information) may be incorporated into PDRO Server 102 and stored within a database such as Transaction Database 106.

In accordance with some embodiments, detailed information about retail establishments, as may be preferred to provide at least some of the features described herein, such as products offered, retailer details, PDRO account access credentials, etc. may also be stored within (or otherwise accessible to) Personalized Digital Retail Offer System 100 (e.g., using Retail Establishment Database 112).

In accordance with some embodiments, an offering entity server 130 and/or an offering entity 140 may comprise servers of entities that are interested in making an offer to customers within the system. These entities may be operable, via an offering entity server 130 or an offering entity server 140, to communicate with the PDRO Server 102 through a network and a wired or wireless connection and provide rules that instruct the details of offers that are presented to customers in accordance with embodiments described herein. Information and details regarding offering entities may, in accordance with some embodiments, be stored in offering entity database 103. In accordance with some embodiments, offer rules provided or selected by offering entities (and described in more detail below) may, in accordance with some embodiments, be stored in an offer rules database 105. In some embodiments, PDRO server 102 may additionally maintain (e.g., within offer database 104) a database of possible offers to be presented to customers.

In accordance with some embodiments, the data and information available via the various servers or components of system 100A as illustrated in FIG. 1A may be by the PDRO server 102 in order to track, facilitate, manage and apply one or more offers that are presented to customers when they are in communication with the system and shopping in retail establishments. For example, customer profiling/machine learning engine 106 may, in accordance with some embodiments, comprise an artificial intelligence software program capable of analyzing at least some of the data within the system, building models of customers, make predictions or inferences based on the data and/or interpreting trends among the data. This engine may also be operable to facilitate the presentation of offers to the customers in the system. More information about how this modeling and profiling may be implemented, is described below.

Turning now to FIG. 1B, illustrated therein is a diagram illustrating an example system 100B, consistent with at least some embodiments described herein. The system 100B may, in accordance with some embodiments, comprise a system implemented in a retail establishment in which products are placed on one or more shelves and a customer may obtain digital retail offers by capturing an image of a shelf of products and submitting it to the system. The system may then analyze the image to identify the products on the shelf (in some instances utilizing supplemental data, such as a location of the customer within the retail establishment), determine whether any digital retail offers are available for any of the products (e.g., based on information associated with the customer providing the image and rules for available offers selected by one or more offering entities) and augment the image of the shelf with any digital retail offers determined for output to the customer (e.g. using AR technology). In accordance with some embodiments, the system 100B may comprise a customer device 122, a network 115B, one or more third-party devices 132a-b (e.g., a retail establishment device 132a and/or an offering entity device 132b), a controller device 142 (which may, in accordance with some embodiments, comprise a PDRO Server), a database device 150, and/or one or more units of product 160a-c (e.g., stored on and/or otherwise associated with a shelf 170). The database 150 may store, for example, at least some of the data described as stored within the databases depicted in FIG. 1A. The system 100B may depict, for example, usage of an AR application on the user device 122 in a retail establishment (e.g., such as a grocery store).

Fewer or more components illustrated in system 100B may be utilized and/or various alternate configurations of the depicted components may be included in the system 100B without deviating from the scope of embodiments described herein. In some embodiments, the components depicted as comprising system 100B may be similar in configuration and/or functionality to similarly named and/or numbered components as described herein (e.g., as described with respect to system 100A). In some embodiments, the system 100B (and/or portion thereof) may be utilized by and/or in conjunction with a PDRO application program and/or platform programmed and/or otherwise configured to execute, conduct, and/or facilitate the method 800 or other methods described herein and/or portions or combinations thereof.

In some embodiments, the customer device 122 may comprise a camera and/or other image input device (not explicitly shown in FIG. 1B) having a field-of-view represented by the dotted lines in FIG. 1B. As depicted, the user device 122 may be utilized to capture an image of the shelf 170 and/or the units or product 160a-c thereon. According to some embodiments, image data from the customer device 122 may be transmitted, e.g., via the network 115B, to one or more of the controller device 142 and the retail establishment device 132a and/or the offering entity device 132b. In some embodiments, the controller device 142 may analyze the image data from the customer device 122 and analyze the image captured by the customer device 122 to identify key data elements and/or features within the image data. The controller device 142 may, for example, compare image patterns in the received image data to image patterns and/or data stored in the database 150. For example, the database 150 may store information regarding available digital retail offers, rules for outputting such, the corresponding product(s) for each offer and one or more key data elements corresponding to a given product that may be utilized by the controller 142 to identify the product in an image. Upon identification of a key data element in the image data, the controller 142 may send data and/or instructions to the customer device 122, or send instructions to the PDRO app stored thereon or update a GUI of the PDRO app stored therein, defining an application and/or functionality thereof that should be activated.

For example, in the case that key data element comprising a brand logo is stored in the database 150, for example, the controller device 142 may analyze image data received from the customer device 122 to determine if the brand logo is present in the image. In such a manner, for example, the controller device 142 may determine an identity of one or more of the units of product 160a-c on the shelf 170 (e.g., of which the image data is descriptive). The controller device 142 may, in some embodiments, use supplemental data to help identify the products on the shelf or narrow in on which key data elements may be in the image. For example, using location data of the customer device 122 (e.g., which may be sent to the controller device 142 along with the image), the controller device 142 may determine which aisle the customer is in and therefore narrow down the set of possible products in the image. The identity of the unit of product 160a-c may be utilized (e.g., by the controller device 142) to identify one or more digital retail offers to be output as enhancements to the image of the units of product 160a-c.

As will be appreciated by one skilled in the art, aspects of the present disclosure and of any of the components of the system 100A and/or the system 100B may be embodied as an apparatus that incorporates software, hardware, and/or firmware components. Any and all of the components of the system 100A and/or system 100B may be implemented as a system controller, a dedicated hardware circuit, an appropriately programmed general-purpose computer, or any other equivalent electronic, mechanical, or electro-mechanical device. Any or all of the components of the system 100A and/or system 100B may comprise, for example, one or more server computers operable to communicate with a plurality of computing devices (e.g., respective customer devices and/or offering entity devices) and/or one or more additional devices such as a gateway server, router devices, or other devices for facilitating digital offers as described herein.

The network 115A and/or the network 155B may comprise, for example, a mobile network such as a cellular, satellite, or pager network, the Internet, a wide area network, another network, or a combination of such networks. Although not shown in FIG. 1A or FIG. 1B, other networks and devices may be part of system 100A and/or 100B; in some embodiments the network 115A and/or the network 115B may comprise two or more networks operable to facilitate the routing of communications among the devices or components illustrated in FIG. 1A and FIG. 1B, respectively. For example, in one embodiment, both the Internet and a wireless cellular network may be involved in routing communications and/or transmitting data among two or more devices or components illustrated in FIG. 1A or FIG. 1B.

The communication between any of the components of system 100A or system 100B, whether via the network 115A, network 115B or otherwise, may take place over one or more of the following: the Internet, wireless data networks, such as 802.11 Wi-Fi, PSTN interfaces, cable modem DOCSIS data networks, or mobile phone data networks commonly referred to as 3G, 4G, 5G, LTE, LTE-advanced, etc.

In some embodiments, additional devices or components that are not show in FIG. 1A or FIG. 1B may be part of the respective systems described therein for facilitating digital retail offers as described herein. For example, one or more servers operable to serve as wireless network gateways or routers may be part of such a system. In other embodiments, some of the functionality described herein as being performed by system 100A and/or system 100B may instead or in addition be performed by a third party server operating on behalf of such systems (e.g., the PDRO System may outsource some functionality, such as registration of new customers or managing the redemption of offers accepted by customers). Thus, a third party server may be a part of a system such as that illustrated in FIG. 1A and/or FIG. 1B. It should be understood that any of the functionality described herein as being performed by a particular component of the system 100A and/or system 100B may in some embodiments be performed by another component of the system 100A and/or system 100B and/or such a third party server. For example, one or more of the functions or processes described herein as being performed by a PDRO Server 102 (e.g., a module or software application of the PDRO Server 102) or another component of system 100A or system 100B may be implemented with the use of one or more cloud-based servers which, in one embodiment, may be operated by or with the help of a third party distinct from the PDRO System. In other words, while in some embodiments the PDRO System may be implemented on servers that are maintained by or on behalf of an entity managing or operating the PDRO System, in other embodiments it may at least partially be implemented using other arrangements, such as in a cloud-computing environment, for example.

It should be noted that the examples provided herein of what type of information may be included or utilized by the PDRO system including examples of the data, should not be taken in a limiting fashion. Modifications can be made as to what type of information is stored with which type of data, different types of data may be combined, some information may be stored with more than one type of data, etc.

Further, although not shown in FIG. 1A or FIG. 1B, the PDRO Server 102 (FIG. 1A) and/or the controller device 142 (FIG. 1B) may further comprise one or more processors and one or more software module(s) for directing the processor thereof to perform certain functions. In accordance with some embodiments, software components, applications, routines or sub-routines, or sets of instructions for causing one or more processors to perform certain functions may be referred to as “modules”. It should be noted that such modules, or any software or computer program referred to herein, may be written in any computer language and may be a portion of a monolithic code base, or may be developed in more discrete code portions, such as is typical in object-oriented computer languages. In addition, the modules, or any software or computer program referred to herein, may in some embodiments be distributed across a plurality of computer platforms, servers, terminals, and the like. For example, a given module may be implemented such that the described functions are performed by separate processors and/or computing hardware platforms.

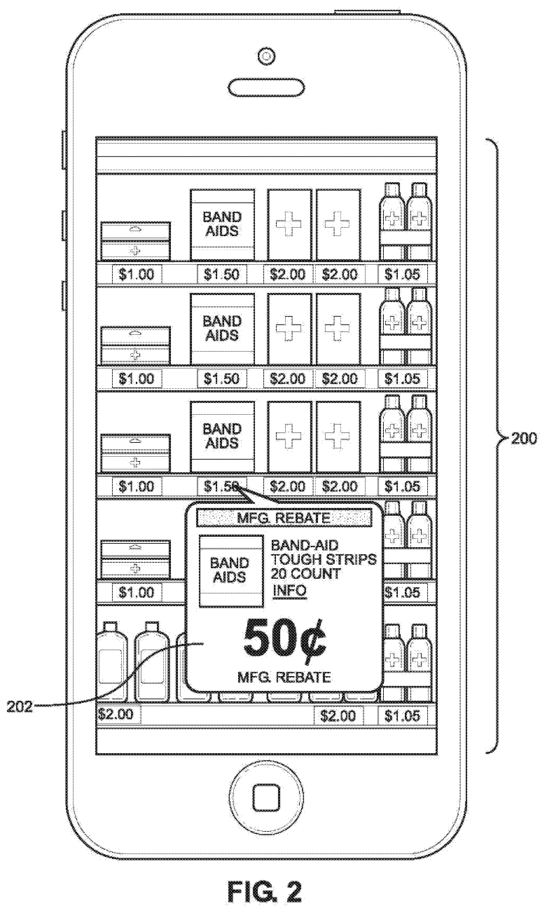

Turning now to FIG. 2, illustrated therein is an example Graphical User Interface (GUI) 200 of a PDRO app that may be downloaded onto a customer device and used by a customer to receive digital retail offers for one or more products the customer is considering purchasing. In the example of FIG. 2, the customer device comprises a smartphone. In accordance with some embodiments, a customer may have captured an image of products on shelves in a retail establishment using a camera of his/her customer device and uploaded the image to the PDRO System using a PDRO System App downloaded onto his/her customer device. In the particular example of FIG. 2, the products illustrated in the image output on GUI 200 are first aid type of items, such as band aids, first aid kits and antiseptic solutions. In accordance with some embodiments, it may be assumed that the PRDRO Server (e.g., PDRO Server 102 of FIG. 1A) has analyzed the image (e.g., by identifying key data elements in the image) and identified a digital retail offer that is associated with at least one of the products in the image (e.g., by identifying the product using the key data elements and retrieving a digital retail offer associated with the image). The particular digital retail offer is indicated in graphic 202 which has been superimposed onto the image of the products captured by the customer device. In the particular example of FIG. 2, the digital retail offer comprises a manufacturer's rebate that is available for one of the products in the image (the product to which the graphic is pointing). It may be assumed that the digital retail offer indicated in graphic 202 has been selected for output to the user based on one or more offer rules associated with that digital retail offer. In some embodiments, the selection of a particular digital retail offer to be output to the customer via a GUI such as GUI 200 may be based at least in part on information associated with the customer (e.g., customer information stored in a PDRO account of the customer).

In some embodiments, a graphic indicating a digital retail offer may include a mechanism for user input, such as a mechanism for the customer to accept the digital retail offer indicated in the graphic (e.g., an “accept” button) or may be swiped or manipulated in a first manner in order to indicate an acceptance of the offer or swiped or manipulated in a second manner in order to indicate a rejection of the offer.

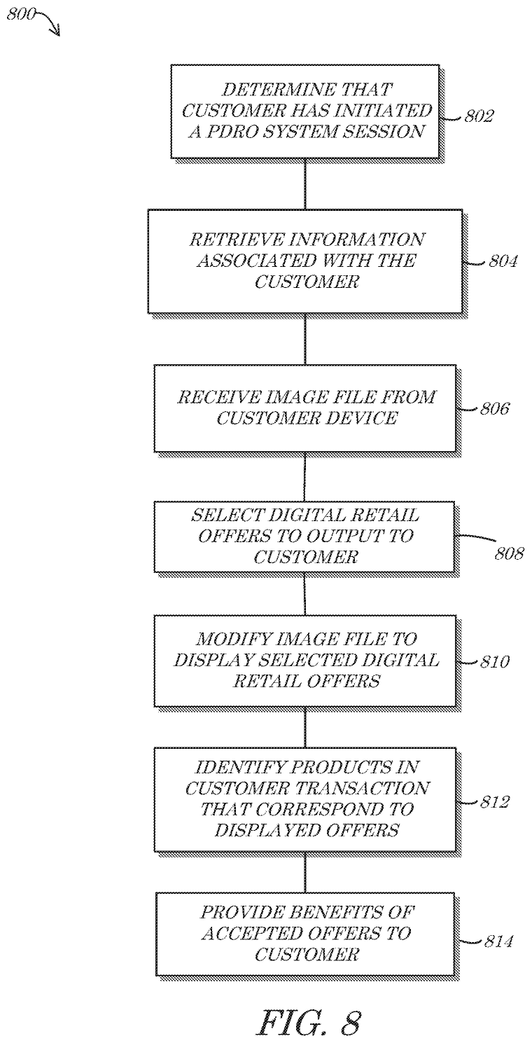

Referring now to FIG. 8, illustrated therein is a process 800 that may be performed by an PDRO System in accordance with some embodiments described herein. Process 800 comprises an example process for dynamically determining one or more digital retail offers to output to a customer while the customer is shopping at a retail establishment and reconciling the output offers against the items purchased by the customer at the end of the shopping visit, to apply any benefits defined by any of the offers output to the customer to items the customer ended up purchasing. The process 800 may be performed, for example, by the PDRO Server 102 (FIG. 1A) or the controller device 142 (FIG. 1B).

The process 800 may begin, for example, upon receiving an indication that a customer has initiated a PDRO System session (step 802). This may comprise, for example, receiving a request from a customer for a digital retail offer. A customer may do this, for example, by logging into a PDRO app on his customer device and/or submitting at least one image of at least one product as captured by a camera of the customer device. This may indicate to the PDRO System that the customer is currently physically present at a participating retail establishment and desires to receive digital retail offers for the products in the image.

In accordance with some embodiments, in order to identify one or more digital retail offers for the customer the PDRO System may first identify the customer and retrieve information associated with the customer, such as profile information or account information stored for the customer by the PDRO System (step 804). This may comprise determining a unique identifier or account identifier of the customer who has initiated the PDRO System session.

In accordance with some embodiments, when a customer opts into the PDRO system, or elects to participate in the PDRO System and thus receive digital retail offers therefrom, the customer may first create an account with the PDRO System that allows the PDRO System to create a profile of information about the customer. As described above, profile information may comprise various types of profile information, such as: (i) data provided by the customer, or by accounts that the customer provides access to; (ii) purchase history and system tracking information that the system collects as the customer participates in the PDRO System; and (iii) assumptions or inferences made by the system based on analysis of actual customer data (e.g., purchase history data), and aggregate or anonymous purchase data received from retailers and other entities.

In one embodiment, a customer may be asked to create an account with the PDRO System when he/she downloads a PDRO app onto his mobile phone or other customer device. In one embodiment, each customer who registers with the PDRO system may be assigned a unique identifier or account number. In some embodiments, the PDRO system uses this unique identifier to select one or more digital retail offers for output to the customer. For example, the PDRO app on the customer device may automatically transmit the unique identifier associated with the customer to the PDRO system along with an image when a customer uses the PDRO app on his customer device to transmit an image of products to the PDRO system in order to receive digital retail offers. The PDRO system may then utilize this unique identifier to access the customer's profile data and utilize this data, along with the key data elements in the image that identify one or more products in the image, to select one or more digital retail offers to output to the customer via the customer device (e.g., using AR technology to overlay graphics comprising the one or more digital retail offers onto the image of products captured by the customer device, such as in a GUI of the PDRO system app on the customer device).

In accordance with some embodiments, the customer may provide information to the system (e.g., via a registration process or post-registration process). For example the customer may be asked to provide information via an online form or may provide information to a representative of the system. In one embodiment, the customer may provide information via polls administered by the system. For example, as the customer participates, the system may intelligently administer polls or surveys to collect information such as: (i) shopping information, such as brand preference, or likelihood of purchasing a particular brand or product; (ii) personal information, such as demographic information that may fill gaps in the customer's profile information. In some embodiments, the customer may grant permission to the PDRO System to access one or more other existing accounts of the customer. For example, the PDRO System can be designed to integrate with, communicate with or receive information from one or more of the following types of accounts associated with the customer: (i) social media networking accounts; (ii) online retailer or product subscription accounts; (iii) employer account information; (iv) healthcare provider information; (v) periodical subscriptions; (vi) media accounts, such as video or music streaming services, online periodicals, etc. (e.g., Netflix™, Spotify™, The New Yorker™ Online); (vii) internet browser information or search histories. In some embodiments, customers may opt into and/or be rewarded for providing access to private information that may be managed by a third party, such as the foregoing.

In accordance with some embodiments, once the customer's account is established as a part of the system, the system may track at least some of the customer's activity and store an indication of it in association with the customer (e.g., in association with a unique identifier or account identifier for the customer). Referring again to FIG. 1A for example, in some embodiments when a customer uses customer device 110 to access the PDRO Server 102, a customer's purchase information may be retrieved (e.g., through the system's connection with, or ability to communicate with, Retail Establishment Server 120). Similarly, in some embodiments at least some of the interactions that the customer has with the PDRO System may also be tracked and an indication thereof stored for future reference.

In accordance with some embodiments, the PDRO system may track individual customer purchase activity, and/or other interactions with the PDRO System. Information can be used to discover trends or make predictions or inferences by analyzing customer purchase histories (e.g., single customer purchase histories). For example, over time, the system can collect and store information about purchases made by a particular customer. In accordance with some embodiments, such information may include purchases made at different retail establishments participating in the PDRO System. In such an example, substantial information about a customer may mean that aggregate cohort modeling or customer modeling may not be utilized in order to make assumptions, inferences or predictions about the individual customer. For example, the system may determine that for certain trends and tendencies, there may be enough information about an individual's purchase history to make assumptions, inferences and/or predictions about the customer's buying habits or preferences.

For example, a customer's purchasing history may show one or more of the following: (i) that customer is price sensitive when shopping for snacks like chips and pretzels, however will not compromise when shopping for soap; (ii) that the customer rarely purchases junk food during the summer, but often does in the winter; (iii) that the customer purchases large amounts of ice cream, more than most customers, but only of one particular brand; (iv) that the customer is very price sensitive when it comes to purchases of eggs—he or she always purchases the brand on sale; (v) that the customer is brand loyal when it comes to toilet paper but not other paper products (e.g., he or she frequently purchases multiple brands of facial tissue and paper towels, however will only make purchases of one specific toilet paper brand; (vi) that the customer always buys organic produce, or that the customer will sometimes buy organic produce, or that the customer never buys organic produce; (vii) that the customer tends to buy products that come in recycled packaging; (viii) that the customer tends to buy gluten free products; (ix) that the customer infrequently uses coupons; (x) that the customer always uses coupons for 5 particular brands; (xi) that the customer normally purchases clothing throughout the year, however he/she has not made a clothing purchase in the last 6 months; (xii) that the customer normally buys Coca Cola™ products, but recently switched and began purchasing Pepsi™ products; and/or (xiii) that the customer normally purchases meat products, but has not in the last 8 months.

In some embodiments, a single customer's behavior may serve as customer model when he/she has accumulated lots of data in the system. For example, if an abundance of information is available about Customer A but there is no information for new Customer B, and Customer A's profile information reaches a matching threshold with Customer B, then the behavior of Customer A may be assumed of Customer B.

In accordance with some embodiments, in addition to specific information stored about one individual customer, the system may perform analysis on aggregate sets of customer profile information and aggregate sets of purchase history information. The PDRO System may, in some embodiments, be designed to incorporate all purchase history data from retailers and product vendors—regardless of whether the purchases are made in concert with the PDRO System. This data can be used to perform similar analysis in order to discover trends or inferences in the data.

For example, the PDRO System may have access to all or much of purchase history data from any organization with access to purchase information, including retail establishments, product manufacturers, transaction data aggregators, loyalty or rewards programs, payment processors creditors and banks, online retailers etc. The system may be designed to support or integrate with various sources of information about purchases made at various types of retailers (e.g., either online or bricks and mortar).

It should be noted that data from different sources may be reformatted and standardized so that groups of data can be stored and analyzed together. This may be done manually, or through an API protocol.

In accordance with some embodiments, purchase history information that may be associated with the customer and utilized by the PDRO to select one or more digital retail offers for the customer may include, without limitation, one or more of the following: (i) one or more product identifiers of products previously purchased by the customer (e.g., ID used to catalogue or identify products, such as a UPC or SKU code, a bar code, model or serial number, QR code, RFID; (ii) a description or data indicative of one or more details previously purchased by the customer (e.g., any relevant information that describes the product, for example name, size, color, model, year, etc.); (iii) a purchase location of one or more products previously purchased by the customer (e.g., the retail establishment location where the product was purchased or identified, such as a location of a particular retail establishment or a location within a particular retail establishment); (iv) Point of Sale (POS) terminal information (e.g., Self-Checkout ID, Cashier ID, POS model, etc.); (v) an indication of a timing of one or more purchases (e.g., a date and time of the purchase); (vi) an indication of stocking information for one or more products previously purchased by the customer (e.g., how long was the product on the shelf? How many were left? Where was the product placed on the shelf); (vii) any additional customer information if available, for example through an online account or loyalty program, such as a customer name, customer identifier, demographic information (e.g., age, gender, income level), contact information (e.g., phone number, residence address).

In accordance with some embodiments, the PDRO System may be operable to use algorithms, artificial intelligence and/or machine learning to analyze purchase history information, and build models of customers and customer behavior. These models and behaviors may evolve as the system collects new information. Customer modeling enables the system to enrich each individual customer's profile by tagging it with observed patterns of purchasing behavior. As models of customers become more and more specific to the characteristics of the customer, the system may be operable to provide the customer with more relevant digital retail offers, and/or may be operable to provide vendors or other offering entities with better data and stronger offer targeting.

Aggregate analyses of such data by artificial intelligence programs can, in some embodiments, be used to discover broad patterns and to build models of customers that exhibit sets of similar characteristics. For example, trends might appear by looking at the purchase activity of customers between the ages of 20 and 25. In another example, a trend might be discovered about customers making purchases a particular times of day.

In some embodiments, the system may make assumptions of “likeness” or similarities or shared characteristics for groups of customers. Similarities in purchasing behavior can be used to make assumptions about groups of members, or a cohort. Cohorts can be established based on any kind of similarities in customer profiles and characteristics, including: (i) demographics such as age, race, gender, marital status, income, education and occupation; (ii) purchase history; (iii) relationships; and (iv) location information.

In some embodiments, assumptions drawn from aggregate analyses of such data may be used to supplement trends, inferences and assumptions made about a customer's individual profile and purchasing information. For example, purchasing behaviors and trends discovered about groups of customers or customers with similar characteristics may be linked or tagged to a customer's individual profile. For example, a customer's individual information may show that he/she never purchases yogurt. However, analysis of aggregate data shows that people from the same region and age group of the customer purchase yogurt at an above average rate. In another example, a customer's individual information may show that he or she purchases standard eggs, whereas the analysis of aggregate data show that people of the same occupation and income class are more and more frequently purchasing free-range eggs. In yet another example, a customer's individual information may show that he or she tends to buy jeans with an acid-wash style, however the aggregate data show that most purchasers of jeans are purchasing darker colored jeans.

In some examples, the profiles may include abundant customer identification data. In some such embodiments, purchase history and other profile information can be tied directly to a specific customer in the system, and that data can also be used to enhance customer and cohort modeling.

For some data sets, purchase history information may only include partial customer identification (i.e., customer profile) information. In accordance with some embodiments, the system can use the customer identification information to connect the purchase history information with customer profile characteristics. This may enable the system to link purchasing behavior to people within a cohorts. For example, digital health records may be incorporated into the system. From such information, the system may be able to determine that people with diabetes tend to purchase significantly more vegetables than fruit. In another example, the system may have access to purchase history information that contains store loyalty card information. The loyalty card info provides the gender and age of the customer making purchases. This information can be used by the system to build demographic based models of purchases. The system may be able to determine that males, age 29 and under purchase 75% fewer tobacco products than males over 30 and over.

For some data sets and in some embodiments, purchase history information may be anonymous. For example, such data may be used to build “models” of customers based on inferences. If demographic information is missing, the system may still be able to make assumptions of demographic and customer information based on the types of items purchased. Examples of demographic assumptions may include: (i) a transaction that includes baby formula and diapers, the system can make a reasonable inference that the customer is a parent of a newborn; or (ii) tiers of purchase amounts may be used to make determinations about a customer's income.

In accordance with some embodiments, identified trends and assumptions may change over time. In some embodiments, machine learning and artificial intelligence may be utilized to take this into account. Continuous or ongoing collection and analysis of purchasing histories—whether of participating customers or of non-participating customers—may be utilized in some embodiments to enable the system to discover and react when new trends develop and old trends fade. For example, if a customer loses his or her job, he or she may become more price conscious. This person may become less brand loyal and more price sensitive. He or she may stop buying luxury items and only purchase out of necessity. Conversely, for example, a customer may receive a raise and become less price sensitive and more brand loyal. In one example, a fashion trend may cause sales of a particular style of jacket to rise. In another example, an outbreak of salmonella poisoning may dramatically slow sales of chicken, perhaps specific to a particular brand of chicken.

As shown in the examples described herein, besides sensitivities about price and brand loyalty, customers may have a “bias” that determines the types of products they will purchase. Examples of a bias include personal beliefs, diets, or values that make them more or less likely to purchase particular products. Adherence to these may be discovered though purchasing trends. In another embodiment, customers may be queried or promoted to designate themselves in one or more of these groupings. Such beliefs, diets, values, etc. may be stored by the system as a part of the customer's profile. Examples of these characteristics include: (i) diets (e.g., a customer's dietary restrictions will highly influence the types of purchases he or she makes, for obvious reasons, a customer's diet may be Vegan, Vegetarian, Pescatarian, Gluten-Free, Dairy-Free, Kosher, etc.); (ii) values (e.g., a customer's politics or belief system may influence the types of purchases he or she makes; a customer's values may include Environmental Sensitivity, such that the customer may only purchase products that can be recycled or preferences for Organic foods such that the customer may only purchase organic products when possible).

In accordance with some embodiments, the PDRO System may be operable to use profiling information and/or purchasing data history information to determine a customer's time-based value. For example, the system can make inferences and predictions about how much a particular customer may spend in a month, a season, a year, a particular stage of life, or throughout that person's entire lifetime.

A time-based value may be expressed or calculated in a variety of manners. In one example, a customer's time-based value may be calculated or expressed for a particular product category, which may comprise an indication of how much a customer can be expected to spend on groups of products per period of time. For example, a customer may be expected to buy X number of shirts per year or X pounds of fruit over the course of his lifetime. In another example, a time-based value may be calculated or expressed for a specific product or brand, which may comprise an indication of how much can a customer be expected to spend on a specific product or brand per period of time. In yet another example, a time-based value may be calculated or expressed in terms of total expected spending over a particular period of time, which may comprise calculating a monetary value or range of values predicting how much a customer may be expected to spend on all purchases over a given period of time.

All or some of the profiling information discussed above may, in some embodiments, be taken into account by a system or algorithm that is designed to calculate a customers' value over time. Following are some examples of factors that may be a focus of such a system, for purposes of demonstration. These factors are not the only factors, but have been included as examples since they may exhibit dramatic effects on a person's time-based value:

(A) Information that is a part of the customer's profile:
(i) A customer's family and dependents—for example, customers who are parents of large families will buy much more food than single couples;
(ii) Location of residence—prices of products and the cost of living are fundamentally different from area to area. Additionally, some examples of factors that may influence quantity of purchase, include:
   Customers in rural areas may be determined to spend much more on detergent and laundry than people in urban areas;
   Customers in warmer climates may be determined to purchase less clothing than people in seasonal climates; and
   Customers in rainy climates may be determined to purchase more ‘comfort food’ like soups.
(iii) Personal hobbies or activity—hobbies and interests may have a large influence on a person's spending. For example:
   Customers who belong to gyms may be determined to purchase more dietary supplements and thirst quenchers, than people who do not; and
   Customers who are artists may be determined to purchase more craft products than people who are not.

(B) Tendencies and assumptions about a customer's cohort:
(i) Customers who purchase an abundance of organic vegetables may be less likely to spend money on chips and other junk foods;
(ii) Customers 50 years old and older, are less likely to have young children, and may therefore be less likely to purchase foods, snacks, or other products that are targeted for young children.

(C) Personal purchasing trends—customers' personal purchasing histories may be directly referenced when making an evaluation of the products, brands and quantities a person will purchase. For example:
(i) A customer that tends to make healthy purchases may be less likely to purchase soft drinks, and therefore may have a lower time-based value for soft drink manufacturers.

(D) Changes in trends or environmental factors. For example:
(i) The season may affect time-based value assumptions; and
(ii) A drought may affect time-based value assumptions.

(E) Dietary restrictions or personal values. For example:
(i) A conversion to a gluten-free diet may affect value based assumptions;
(ii) A vegetarian may be assumed to buy much more tofu-based products than a meat-eating customer.

In accordance with some embodiments, once an expected number of purchases over the specified amount of time has been determined, a calculation may be made to put an amount of money that the customer is “worth” to a particular brand or particular offering entity. For example, the time-based value being determined may be the amount of money a particular customer will spend over the course of 5 years. If the customer was projected to buy 80 gallons of milk per year, and milk costs $4.00/gallon, then the customer's time-based value may be calculated to be 80*4*5=$1,600.

Of course, other factors that may be considered when making a time-based value calculations. Examples of these include, without limitation: (i) projections for product price inflation; (ii) calculations for Net revenue vs. Gross revenue; (ii) calculations that take a particular digital retail offers or other discounts into account; (iii) expected fluctuations in purchases based on life events (e.g., having children or getting married).

In accordance with some embodiments, time-based values such as those discussed herein may be provided to offering entities, or used in creating or applying offer rules, and used to make a determination about whether a particular digital retail offer should be presented to a particular customer.

It should be noted that, in accordance with an alternate embodiment, the PDRO system may not need an affirmative request from a customer in order to present digital retail offers to the customer (as indicated in step 802 of process 800). For example, in one embodiment digital retail offers may be presented passively. For example, customers may not be required to interact with the PDRO System in order for digital retail offers to be output or presented to them. In such an embodiment, customers may receive text based or audio messages on their customer device when a digital retail offer is available. Additionally, in some embodiments digital retail offers may be triggered based on a passive connection with a product or retail establishment devices. For example, customer's device may passively interact with one or more of the following in a retail establishment: (i) inaudible signals played throughout the retail establishment that are detectable by the customer device; (ii) location-based sensors within the retail establishment (e.g., a customer's position in the retail establishment may be determined through passive connections with beacons; any number of known location triangulation methods may be used and/or audio and radio signals may be used to determine the position of the customer's device; (iii) RFID sensors in products that may output signals readable by the customer device; (iv) visible product identifiers (e.g., the customer device may include optical sensors that may read or detect such identifiers without pro-active input of the customer).

Returning now to process 800, the system receives at least one image file from the customer device, the image file depicting at least one product (step 806). In accordance with some embodiments, the system analyzes the image file to identify the one or more products depicted in the file (e.g., by identifying any key data elements in the image, such as brands, logos, shapes of containers, etc.). In accordance with some embodiments, the system may be operable to identify additional data, external to the image file but related to the customer request, that may help identify the one or more products depicted in the image. For example, the system may determine a location of the customer within the retail establishment (e.g., a particular aisle, part of an aisle, or side of an aisle) that the customer is located in. This may be done, for example, based on triangulation of a signal from the customer device or information received from one or more sensors within the retail establishment. In one embodiment, the location of the customer within the retail establishment may be determined based on information within the image (e.g., shelves in the retail establishment may bear identifying information in particular locations, such that the system may analyze the image in order to read such information and therefore determine the location of the customer).

Turning briefly to FIG. 2, illustrated therein is an example GUI 200 that is output on a customer device, comprising an image of products on a shelf as it was captured by the customer device. The PDRO System may user any number of means to determine what products are on the shelf as shown in the image, such as evaluating the image for key data elements. Examples of such key data elements include data elements comprising data useful in identifying a product, such as: a Stock Keeping Unit (SKU); a Universal Product Code (UPC); a brand logo or brand name; a serial or model number; a Radio Frequency Identification Tag (RFID Tag); a Quick Response Code (QR); Packaging shape, design, or graphic; a product location. In accordance with some embodiments, GUI 200 also illustrates an offer graphic 202 defining a digital retail offer being output to the customer for a particular product in the captured image. Example embodiments of how such a digital retail offer may be identified or selected for output to the customer will now be described.

Once the information about the customer is determined or retrieved (804) and the one or more products depicted in the image provided by the customer are identified (806), the system may determine whether any digital retail offers or types of offers are to be output to the customer (step 808). For example, the system may determine whether there are any digital retail offers associated with the one or more products in the image and, based on the one or more offering rules or conditions associated with such offers as compared to the information about the customer, determine whether a particular offer should be output.

In accordance with some embodiments, offering entities may provide (e.g., fund and define) digital retail offers and offer rules associated therewith. An offer rule may comprise a rule that defines a pre-requisite or criteria that must be satisfied in order for the corresponding digital retail offer to be output to a customer. A particular offering entity may select or define one or more offer rules based on customer profile data and their own particular goals or desires for outputting the digital retail offers. In one embodiment, step 808 may comprise determining whether the information associated with the customer and/or the image satisfies one or more rules associated with one or more digital retail offers that are available for the one or more products in the image received in step 806.

In accordance with some embodiments, the PDRO System may include, communicate with, coordinate with, receive offers from or otherwise involve offering entities (if the PDRO System is not managed by an offering entity itself). As described herein, an offering entity is an entity that makes digital retail offers to customers via the PDRO System.

One example of an offering entity is a product vendor. A product vendor may offer digital retail offers comprising discounts, subsidies and/or instant rebates to drive trial purchases, allow vendors to compete with competitors and boost sales volume. Another example of an offering entity is a retail establishment; this type of offering entity may offer digital retail offers comprising discounted prices as a mechanism to incent the purchase of clearance items and/or products with a short shelf life, or just to incent new customers. Yet another type of offering entity is an employer; this type of offering entity may have an interest in funding healthier choices with digital retail offers to help keep workers well and productive. Yet another type of offering entity may comprise a health insurer, which may provide digital retail offers comprising discounted prices and instant rebates to incent choices that hold down costs for items that support current treatments or conditions. Yet another type of offering entity may comprise adult children of older parents or family members located anywhere, who may be interested in funding digital retail offers for their family members comprising discounted prices on certain items to encourage healthier choices. Yet another type of offering entity may comprise a co-op marketing associations or councils, which may fund digital retail offers to boost customer awareness and efficiently promote their industry's products. Yet another type of offering entity may comprise health-focused government agencies, which may fund digital retail offers comprising discounted prices to incent healthy or low-cost choices such as fresh food, generics or approved store brands. Yet another type of offering entity may comprise a local business, which may fund digital retail offers in order to provide discount items related to their business that encourage new or current customers. Yet another type of offering entity may comprise store brands and generics, which may fund digital retail offers targeting customers who are considering buying the competitive national brand (e.g., with a one-time instant rebate on the store brand to generate trial).

In some embodiments, an offering entity may comprise an entity not traditionally associated with providing discounts or other offers to customers in a retail establishment. For example, one type of offering entity may comprise agencies at the state and local levels that may fund digital retail offers such as instant rebates through programs that assist defined populations such as expectant mothers. Yet another type of offering entity may comprise charities, philanthropic organizations and non-profit groups that may fund digital retail offers such as discounted price offers to provide direct aid to individuals and groups in need of assistance for specific items such as relief supplies. Yet another type of offering entity may comprise industries with large customer acquisition budgets such as car dealers or OTC drug companies, which may fund digital retail offers such as instant rebates to incent shoppers to try their product—such as taking a test drive in a new car. Yet another type of offering entity may comprise religious organizations that may fund digital retail offers such as instant rebates and free items as a way to provide anonymous and efficient support to their own members in need.

In accordance with some embodiments, an offering entity may be in communication with the PDRO System, which may, in some embodiments, include providing to the offering entity access to customer profiling information (which, as discussed above, may include purchase histories) and time-based value information for customers. In accordance with some embodiments, offering entities may participate in the PDRO System, as described with reference to FIG. 1A and FIG. 1B, via network 115A or network 115B, by communicating with PDRO Server 102 (FIG. 1A) or controller 142 (FIG. 1B). In accordance with some embodiments, an offering entity may be allowed to access data and information stored in and/or determined by the PDRO System in order to make determinations such as whether to create a digital retail offer and to which customers (or types of customers) a digital retail offer created by them should be made (e.g., based on one or more offer rules selected by the offering entity as corresponding to a particular digital retail offer).

In one example, an offering entity may be provided with the raw data that they can sort, parse, and use it to draw their own conclusions. In another embodiment, such data can be provided to an offering entity using various skins and graphical treatments to demonstrate customers' value to the offering entity at a higher level. For example, offering entities may be given toggles and options to sort, parse, manipulate and evaluate the data using the PDRO System interface. In one embodiment, the PDRO System may provide an open API to allow a third party such as an offering entity to develop new ways to access, analyze and view customer profile information and time-based value information. In some embodiments, an offering entity may not be able to access to customer profiling information of the system directly but may instead be provided with reports or summaries based on this information collected by the system.

In one embodiment, at least some of profiling information and/or time-based value information described herein may be made available to at least some offering entities (whether directly or in a report or summary format). In another embodiment, offering entities may only be able to view customer profiling and time-based value for retail establishments where their products are offered for sale. In another embodiment, offering entities may be able to view customer profiling and time-based value for any retail establishment, regardless of whether their product is available at a given retail establishment. In yet another embodiment, only profiling and time-based value information relevant to the offering entity may be made available. For example, if the offering entity is the vendor of a product or group of products in a store, they may only be shown information about purchases and customers of that particular product. In another example, if the offering entity is an employer, they may only be able to see information related to their employees. In such an example, employees may opt into connecting their account with the employers. In another example an employer may register employees' accounts.

In one embodiment, offering entities may not be shown any customer profiling and/or time based value information or only a limited portion of such information. This may be because the information is either not relevant, or deemed to be a breach of privacy. For example in the case of the employer as offering entity, it may not be necessary or desirable for an employer would need to see the customer's profile, because they aren't interested in driving sales or making a profit. Rather, their interest more broadly is to incent healthy choices. In such an embodiment the offering entity may only have access to create and submit digital retail offers and business rules for use in the system.

As described herein, in accordance with some embodiments, offering entities accessing the PDRO System (or otherwise communicating with the PDRO System) may be given the ability to create digital retail offers and set rules to be used by the system to determine when to present customers with digital retail offers (e.g., which customers to present a particular offer to, under what circumstances a particular offer should be presented, how often an offer should be presented, etc.). In some embodiments an offering entity may be allowed to select from a menu of available rules and/or to select one or more values for one or more parameters defining available rules when submitting a digital retail offer to the system.

As described above, in some embodiments digital retail offers set up by offering entities may be associated with one or more rules that define when a digital retail offer will be made. These rules may include one or more variables that determine the offer's details and requirements or conditions for presentation. In some embodiments, at least some of the types of profile information and time based value information described herein may be used to create requirements that trigger the presentation of a digital retail offer to a customer or type of customer. For example, if the system has collected or created data about customers and their purchases, in one implementation a presentation requirement can be created based on that data.

For illustrative and non-limiting purposes, some example types of offer variables (one or more of which may be utilized to determine whether a particular digital retail offer should be output to a customer) will now be described. In one example, an offer rule may define a product or group of products for which to present the digital retail offer (e.g., present this offer only for Hershey's™ Kisses™ vs. present this offer for all Hershey's™ products). In another example, an offering entity may choose from groups of products that are not already linked together, or choose from groups of products that have been created by other offering entities. In one embodiment, the PDRO system may use artificial intelligence or algorithms to link products based on product information. For example, “All organic Products” Or “All products purchased by vegetarians”. Accordingly, an offer rule may direct the system to “output this offer for all products on the ‘Healthy List’” or “output this offer for all products that are low-carb” or “output this offer for all products that are gluten free.”

Thus, an offering entity may select or create offer rules that are intended to result in its digital retail offers being presented to customers whom the offering entity considers particularly valuable or beneficial to connect with. For example, an offering entity may elect to have its digital retail offers presented only to customers associated with a particular time-based value or range of value. For example, an offering entity may select an offer rule that indicates that a particular digital retail offer should only be presented to customers who have a corresponding threshold time-based value amount.

In some embodiments, an offering entity may create rules that determine which retail establishments will support the digital retail offers of that offering entity. For example, the offering entity may want to determine exactly where the digital retail offer can be presented, and may want to exclude specific areas of a retail establishment or particular retail establishments where a digital retail offer is output.

In some embodiments, an offer rule may comprise a time-based requirement. For example, an offering entity may select an offer rule that restricts a particular digital retail offer to be output only on weekends or after a certain time of day (e.g., after 5 pm).

In some embodiments, an offer rule may comprise a stocking requirement. For example, the offer rule may define that a corresponding digital retail offer be output only once a corresponding product is set to expire within x days or when there are only x amount of product units in stock.

In some embodiments, an offer rule may comprise an environmental factor. For example, the offer rule may define that a corresponding digital retail offer be output only when the weather temperature reaches x degrees or only when it's raining.

In some embodiments, an offer rule may comprise a conditional requirement. For example, digital retail offers defining discounts or promotional prices may make such benefits immediately available to a customer once the customer accepts the offer and purchases the product for which the offer was made, or may be conditional based on an action required of the customer. Examples of conditional requirements may include: (i) providing responses to polls; (ii) watching an ad; (iii) sharing an ad with friends; (iv) posting about the product on social media; (v) making multiple purchases of the product; or (vi) purchasing another product in combination with the product.

In some embodiments, an offer rule may comprise a requirement or factor based on a customer's previous purchases. For example, at least some of the purchase history information discussed herein may be used as a requirement to trigger the presentation of a digital retail offer. Some examples include: (i) whether a customer has made a purchase of a product in the past; (ii) how recently a customer has made a purchase of a product in the past; (iii) whether a customer has purchased a related product (and, in some embodiments, how recently); and (iv) whether the customer has purchased a competitive brand (and, in some embodiments, how recently).

In some embodiments, an offer rule may comprise a customer assumption or cohort requirement. In one embodiment, one or more of the assumptions and cohort assignments made by analyses described above may be used as a requirement to trigger the presentation of a digital retail offer. For example, an offer rule may indicate that a corresponding digital retail offer is to be output if a customer is part of a cohort: (i) that has made a purchase, or particular purchase, within the past X period of time; (ii) in which >50% of customers buy a defined product; and/or (iii) that has a time-based value of X.

In some embodiments, an offer rule may comprise a customer profile requirement. In one embodiment, one or more of the customer profile information types described above may be used as a requirement to trigger the presentation of a digital retail offer. Examples of such customer profile information types include: (i) a customer demographic (e.g., that the customer is of a particular age, age range, gender, marital status, income, education and occupation, etc.); (ii) a customer is associated with a particular “bias” or preference, such as a dietary restriction or belief system (e.g., a particular digital retail offer is to be output to customers who are categorized as vegetarians or customer who are not categorized as preferring kosher foods).

In accordance with some embodiments, the PDROS system may be designed to learn and adapt over time. For example, in some embodiments the PDROS System may include artificial intelligence and/or machine learning abilities such that the profiling and modeling described herein may be used by the system's artificial intelligence in order to become more efficient in the types of offers that customers are shown. For example, profile information may determine that customers who are 75 and older in southern California are more likely to buy a brand of macaroni and cheese. Initially the system may suggest that purchasers of this brand of macaroni and cheese also buy milk, since it's one of the ingredients needed to make the dinner. However, over time the system may notice that not only are these customers in this particular area not following the trend to take the offer for the milk, but that they also tend to buy tofu and meatless products. Since the system labels these products as vegan, and the system recognizes that milk is not vegan, it may begin to suggest milk substitutes such as soy and almond milk.

In accordance with some embodiments, the system may be programmed with a list of sample offer rules that may be created or selected by offering entities and used to manage the output of digital retail offers to customers. Examples of some such offer rules are provided below, grouped by offering entity type and are intended to serve as non-limiting examples.

Example offer rules that may be made available to offering entities comprising vendors: (i) if customer of competitive brands in the past 6 months, offer 30¢ rebate; (ii) if customer of competitive brands whose purchases exceed $10 in past 6 months, offer 50¢ rebate; (iii) if customer of competitive brands has $50+average cart, offer $1 rebate; (iv) if customer of competitive brands and has children at home, offer $1 rebate on purchase of 2 or more; and/or (v) if customer of vendor's brand in past 6 months totaling fewer than 6 units, offer $1 rebate when you buy 3.

Example offer rules that may be made available to offering entities comprising employers: (i) if customer is employee and is 40 or under and has not purchased this or comparable product in past 3 months, offer 30¢ rebate; (ii) if customer is employee and is over 40 and has purchased this or comparable product in past 3 months, offer 50¢ rebate; (iii) if customer is employee and is over 40 and has not purchased this or comparable product in past 3 months, offer 75¢ rebate; (iv) if customer is employee and is 40 or under buys this product plus GoodSense™ Nicotine Gum (20 piece box), offer $1 rebate; and/or (v) if customer is employee and is over 40, buys this product plus GoodSense™ Nicotine Gum (20 piece box), offer $1.50 rebate. It should be noted that, in accordance with some embodiments, the above examples of offer rules define not only a type of customer to whom a digital retail offers should be made (employees of the employer that comprises the offering entity, in the present example) but also the benefit to be included in the offer.

Example offer rules that may be made available to offering entities comprising health insurers or care providers include: (i) if customer is client or member and has purchased this or comparable product in past 3 months (min. $19.95 price), offer $1 rebate; (ii) if customer is client or member and has not purchased this or comparable product in past 3 months, offer $2 rebate; (iii) if customer is client or member and has purchased tobacco-related products (cigarettes, cigars, tobacco, pipes, rolling paper, ash trays, cigar humidifiers, snuff, etc.) in past year, offer $3 rebate; and/or (iv) if customer is client or member and buys this product plus GoodSense™ Nicotine Gum (20 piece box), offer $3.50 rebate.

Example offer rules that may be made available to offering entities comprising adult children or other family members of the customer include: (i) if customer has purchased qualifying products in past month (min. ½ lb.), offer 30¢/lb. rebate; (ii) if customer has not purchased qualifying products in past month, offer 50¢/lb. rebate; (iii) if customer purchases 3 different kinds of fresh produce on this trip (min. ½ lb. each), offer $3 “basket rebate” on top of 30¢/lb. rebate; (iv) if customer purchases qualifying product (min. ½ lb.), plus 3 cans of low-salt soup, offer $2.50 rebate; and/or (iv) if customer purchases product A, offer 100% rebate on related product B (e.g., purchasing ½ lb. of tomatoes triggers offer of 100% rebate on ½ lb. bag of lettuce).

Example offer rules that may be made available to offering entities comprising co-op marketing associations or councils of which the customer is a member include: (i) if customer has purchased qualifying products in past month, offer 25¢ rebate on any qualifying item (min. price $2.49); (ii) if customer has not purchased qualifying products in past month, offer 50¢ rebate on any qualifying item priced from $2.49-$5.49; and offer $1 rebate on any qualifying item from $2.49-$5.49; (iii) if customer purchases 2 different kinds of crackers on this trip (min. $2.49 each), offer $1 rebate; (iv) if customer has 2 or more people living in home, has purchased qualifying products in past month, offer $1 rebate on qualifying purchase (min. $6.98); and/or (iv) if customer has 2 or more people living in home, has not purchased qualifying products in past month, offer $1.50 rebate on qualifying purchase (min. $6.98).

Example offer rules that may be made available to offering entities comprising AFDC, Medicaid or Medicare programs of which the customer is a member include: (i) if customer has purchased this or comparable product in the past 3 months, offer 30¢ rebate; (ii) if customer has not purchased this or comparable product in the past 3 months, offer 30¢ rebate; (iii) if customer has $35 or less average cart, offer 50¢ rebate; (iv) if customer has 1-3 children ages 2-13 or 2 or more adults age 65 and up at home, offer 75¢ rebate on purchase of 2 or more; and/or (iv) if customer has 4 or more children ages 2-13 at home, offer $1.50 rebate on purchase of 4 or more.

Example offer rules that may be made available to offering entities comprising local businesses (which local business, for purposes of the present example, is a local pet grooming business named Jane's Pet Grooming) include: (i) if customer has purchased any qualifying products in the past 6 months (min. spend $10/trip), offer 30¢ rebate on 1 unit of same product (min. price $7.98)+$2 rebate good at Jane's); (ii) if customer has purchased any qualifying products in past 6 months for 2 different kinds of animals (i.e., dog food+cat food, min. spend $20/trip), offer $1 rebate on 1 unit of same product (min. price $12.88)+$3 rebate good at Jane's; (iii) if customer has purchased $100 or more of qualifying products in the past 2 months, offer $1 rebate on 1 unit of any repeat buy product (min. price $12.88)+$5 rebate good at Jane's.

Example offer rules that may be made available to offering entities comprising store brands and generic or non-brand entities include: (i) if customer is a purchaser of competitive brands in the past 6 months, offer 20¢ rebate; (ii) if customer is a purchaser of competitive brands whose purchases exceed $10 in past 3 months, offer 50¢ rebate; (iii) if customer is a purchaser of competitive brands has $50+average cart, offer $1 rebate for purchase of 2 units or more; (iv) if customer is a purchaser of competitive brands and has children at home, offer $1.50 rebate on purchase of 3 or more; and/or (v) if customer is a purchaser of offering entity's brand in past 6 months totaling fewer than 6 units, offer $1 rebate when you buy 3.

Example offer rules that may be made available to offering entities comprising a state or local welfare agency from which the customer receives benefits include: (i) if customer has purchased this or comparable product in the past 3 months, offer 20¢ rebate; (ii) if customer has not purchased this or comparable product in the past 3 months, offer 30¢ rebate; (iii) if customer has $35 or less average cart, offer 50¢ rebate; (iv) if customer has children ages 2-13 at home or adults age 65 and up at home, offer $1 rebate on purchase of 2 or more; and/or (iv) if customer has 4 or more children ages 2-13 at home, or 2 or more adults age 65 and up at home, offer $2.50 rebate on purchase of 4 or more.

Example offer rules that may be made available to offering entities comprising charitable or non-profit organizations include: (i) if customer is a contributor to the organization or recipient of benefits from the organization, offer 25¢ rebate; (ii) if customer has $35 or less average cart, offer 50¢ rebate; (iii) if customer has children ages 2-13 at home or adults age 65 and up at home, offer $1 rebate on purchase of 2 or more; and/or (iv) if customer has 4 or more children ages 2-13 at home, or 2 or more adults age 65 and up at home, offer 100% rebate ($1.58) per every purchase of 3 units.

Example offer rules that may be made available to offering entities comprising a brand, manufacturer or other company utilizing a new customer acquisition budget in order to attract new customer include: (i) if customer is purchaser of competitive brands in the past 6 months, offer 50¢ rebate; (ii) if customer is a purchaser of competitive brands whose purchases exceed $10 in past month, offer 75¢ rebate; (iii) if customer is a purchaser of competitive brands has $50+average cart, offer $1 rebate; (iv) if customer is a purchaser of competitive brands and has children at home, offer $1 rebate on purchase of 2 or more; and/or (v) if customer is a purchaser of the company's brand in past 6 months totaling fewer than 6 units, offer $2 rebate when you buy 3.

Example offer rules that may be made available to offering entities comprising local churches and religious groups of which a customer is a member include: (i) if customer has $35 or less average cart, offer $1 rebate; (ii) if customer has $50 or less average cart, offer 50¢ rebate; (iii) if customer has children ages 2-13 at home and/or adults age 65 and up at home, offer $3 rebate on purchase of 3 or more; (iv) if customer has 4+children ages 2-13 at home, and/or 2+adults age 65 and up at home, offer $3 rebate on purchase of 3 or more; (v) if customer is a member, offer $2 rebate on purchase+any designated staple (Great Value brands: loaf of bread, 12 oz. sliced cheese, 12.50 oz. cans of chunk chicken breast, etc.).

It should be noted that although some of the examples of offer rules above indicated both the condition(s) under which a digital retail offers should be offered and the benefit defined by the offer, in other embodiments offer rules may only indicate the one or more condition(s) for outputting a particular digital retail offer but the particular parameters of the digital retail offer (E.g., the benefit and/or the product(s) for which it should be made) may be determined and/or stored separately. For example, one table or storage mechanism may store a plurality of digital retail offers with one or more of the following data corresponding to each offer: (i) a type of benefit to be included in the offer; (ii) a value of the benefit to be included in the offer; (iii) one or more products for which the offer is to be made (e.g., one or more products which, if they appear in an image received from a customer device, should cause the system to consider whether the corresponding offer rule(s) allows the offer to be output to a particular customer.

In some embodiments, multiple offer rules may be associated with a given digital retail offer. In some embodiments the corresponding offer may be output if any one of the offer rules is satisfied while in other embodiments all corresponding offer rules must be satisfied before the offer can be output.

Returning again to process 800, once at least one digital retail offer is identified by the system as one to be output to the customer (e.g., based on the customer information determined in step 804, the products in the image identified in step 806 and the offer rules considered in step 808), the system displays or outputs the one or more digital retail offers to the customer (step 810). An example of how a digital retail offer may be output via an offer graphic overlaid on an image captured by a customer device is illustrated in FIG. 2.

In accordance with some embodiments, a customer is presented with a particular digital retail offer once the system determines that the customer meets the one or more offer rules defining requirements for presenting the digital retail offer(s). In some embodiments, the system may further verify that one or more additional requirements are satisfied prior to outputting the digital retail offer(s) to the customer. For example, in one embodiment, the PDRO system will only present digital retail offers if the system can confirm that the customer is actually shopping or physically present in a retail establishment. Some examples of methods that the system may use to confirm the customer is physically present in the retail establishment include: (i) sensor confirmation (e.g., the customer may be required to use sensors such as a camera or QR code reader app of his customer device to detect retail establishment or product information and transmit this to the PDRO server to confirm their presence in the retail establishment); (ii) visual confirmation (e.g., customers may use a camera of a customer device to scan products, or take pictures or video of products in the store and transmit this to the PDRO server to confirm their presence in the retail establishment); (iii) audio confirmation (e.g., customers may use a microphone of a customer device to record an audio tone played by speakers inside the retail establishment and transmit this to the PDRO server to confirm their presence in the retail establishment); (iv) location services provided within the retail establishment (e.g., the PDRO system may determine that the customer is at a retail establishment by prompting the customer to input a temporary code that is available within the retail establishment but that expires or is modified periodically). In another embodiment, digital retail offers may be presented to customers, regardless of whether they are currently shopping in a retail establishment.

In accordance with some embodiments, digital retail offers may be presented to the customer using any available output component of the customer device. In one embodiment, Augmented Reality (AR) software is used to superimpose static or animated graphics (“offer graphic” herein) over or onto one or more images of products that was captured by a camera of a customer device and received in step 804. The resulting image with the superimposed graphics may be output on a display of the customer device (e.g., via a GUI of the PDRO app on the customer device). As described herein, the system may track which offers have been output to a customer during a particular shopping visit (e.g., from a time a customer has initiated a session with the PDRO system in step 802 to a time the customer purchases items at a POS of the retail establishment at which the session has been initiated) and, if it is determined that the customer is purchasing (or has purchased) a product associated with one of the output offers, the PDRO system will cause the benefit of that offer to be provided to the customer.

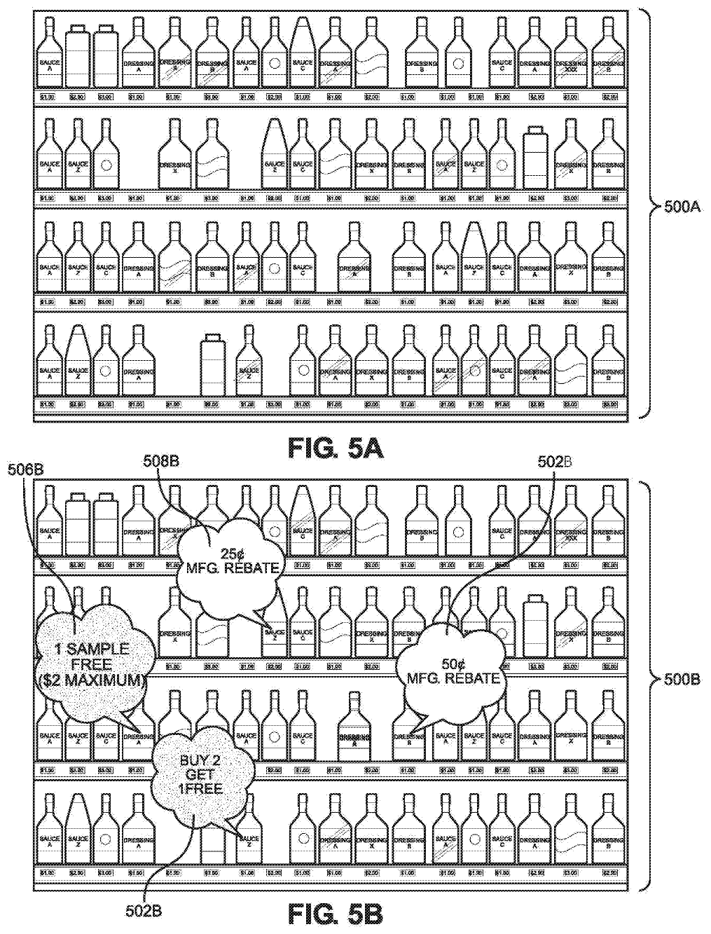

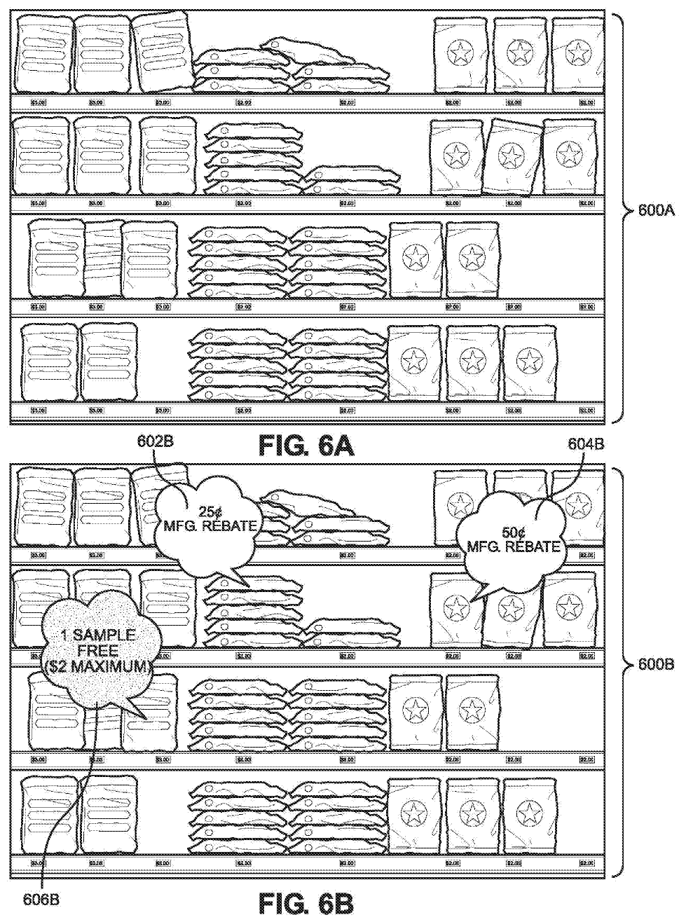

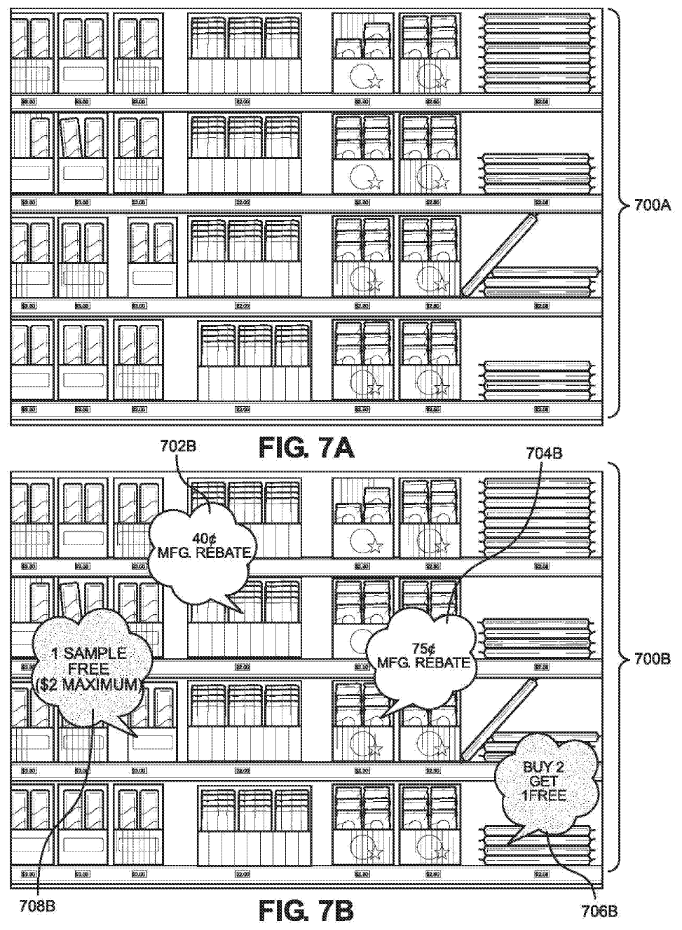

Turning briefly to FIGS. 5A-5B, 6A-6B and 7A-7B, illustrated in each of these pairs of Figures are additional examples of GUIs that may be output to a customer via a PDRO app on the customer device, as each may be modified by the PDRO System to superimpose offer graphics thereon. In accordance with an illustrative example, each of the images in these GUIs may comprise images captured and transmitted to the DPRO System by a particular customer during a particular shopping visit, as the customer is moving throughout a retail establishment. For example, FIG. 5A may comprise an image of products on a first set of shelves in a first area of the retail establishment, FIG. 6A may comprise an image of products on a second set of shelves in a second area of the retail establishment and FIG. 7A may comprise an image of products on a third set of shelves in a third area of the retail establishment.

FIG. 5A illustrates a GUI 500A which illustrates an image of shelves of products, as captured by a customer device (and as, in accordance with some embodiments, may be transmitted to the PDRO system in step 806). FIG. 5B illustrates GUI 500B, which is a modified version of GUI 500A but with a plurality of offer graphics 502B-508B superimposed on the image of the products, each offer graphic defining a digital retail offer that has been selected for output to the customer. FIG. 6A illustrates a GUI 600A which illustrates an image of shelves of products, as captured by a customer device (and as, in accordance with some embodiments, may be transmitted to the PDRO system in step 806). FIG. 6B illustrates GUI 600B, which is a modified version of GUI 600A but with a plurality of offer graphics 602B—606B superimposed on the image of the products, each offer graphic defining a digital retail offer that has been selected for output to the customer. FIG. 7A illustrates a GUI 700A which illustrates an image of shelves of products, as captured by a customer device (and as, in accordance with some embodiments, may be transmitted to the PDRO system in step 806). FIG. 7B illustrates GUI 700B, which is a modified version of GUI 700A but with a plurality of offer graphics 702B-708B superimposed on the image of the products, each offer graphic defining a digital retail offer that has been selected for output to the customer.

In accordance with some embodiments, the digital retail offers represented by the offer graphics in FIGS. 5B, 6B and 7B may be based on the customer information determined in step 804, the products in the image as identified in step 806 and the offer rules considered in step 808). In accordance with some embodiments, the PDRO System may track all of the digital retail offers output to a customer during a particular session or visit to a retail establishment (e.g., the PRDO System may open and update a record in its memory to indicate each offer output during the visit). Thus, for example, for each instance in which the PDRO System causes a modification of an image on a customer device by superimposing one or more offer graphics on the image, the System may also update such a record to indicate each offer indicated by each such offer graphic (e.g., via a unique identifier corresponding to each offer and the product associated with each respective offer, such as the product to which the corresponding offer graphic is made to point to in the modified image).

In some embodiments, an offer graphic may provide a customers with an ability to interact with digital retail offer representations, such as by being able to select information or provide inputs. For example, a customer may be provided with an ability to (i) select the digital retail offers he/she wants to use; (ii) pass a digital retail offer along to other customers or share it with other customers; (iii) actively scan product identifiers in order to see digital retail offers or additional information on digital retail offers.

It is feasible that in some circumstances more than one digital retail offer may be available for a particular product (e.g., the customer's information satisfies the offer rules for more than one offer for a product in an image captured by the customer device). Similarly, there may be a large number of digital retail offers available for the products in the image (even if they are for different products) such that displaying all of the available digital retail offers via offer graphics on the image may be impractical or undesirable because it would result in a cluttered, displeasing or difficult to read image. Accordingly, under either of such circumstances (or other similar circumstances), the PDRO System may need to select which of a plurality of available offers to actually output to the customer.

For example, if more than one digital retail offer is available for a particular product, while in some embodiments all of the available offers may be presented to the customer in other embodiments only one or a subset of the offers may be output. The PDRO System may, depending on the embodiment selected for implementation: (i) display all available offers by adding the benefits together in a cumulative total; in some cases the sum of the benefits may exceed the price of the product such that in effect the customer is getting “paid” in order to purchase the product); (ii) display all offers individually (e.g., the customer may be able to toggle between them, and select the one (or more than one, if such an option is made available) they want to accept; (iii) use an algorithm or rule set (e.g., hierarchy or prioritization scheme) to determine which offers to display and which to suppress or not display; or (iv) randomly select the ones to display.

In one embodiment, in addition to (or in lieu of) displaying digital retail offers, the PDRO System may be operable to display supplemental information about a product. Such information may comprise, for example, information that can be used by the customer to make a decision. This may be information that customers tend to seek when determining whether to make purchases online. Alternatively, this information may be information that the offering entities want to push to a customer (such as customer reviews). Thus, in some embodiments, an image graphic that is output by modifying an image of products may comprise such supplemental information rather than a digital retail offer. It should be noted that the systems and methods described herein as being useful for identifying and selecting one or more digital retail offers to display to a customer may likewise be utilized to identify and select supplemental information to display to a customer.

In one embodiment, the PDRO System may be operable to make supplemental information and/or digital retail offers available as separate “layers” of information that the customer can toggle or switch between. For example, there may be a single type of information that is presented by default, and then the customer may be provided with the ability to toggle or switch through each type of information. In another embodiment, the PDRO System may make a determination of what type of data would be most useful to the customer (e.g., based on a customer's profile, ratings made by other customers, purchase statistics when displayed, etc.).

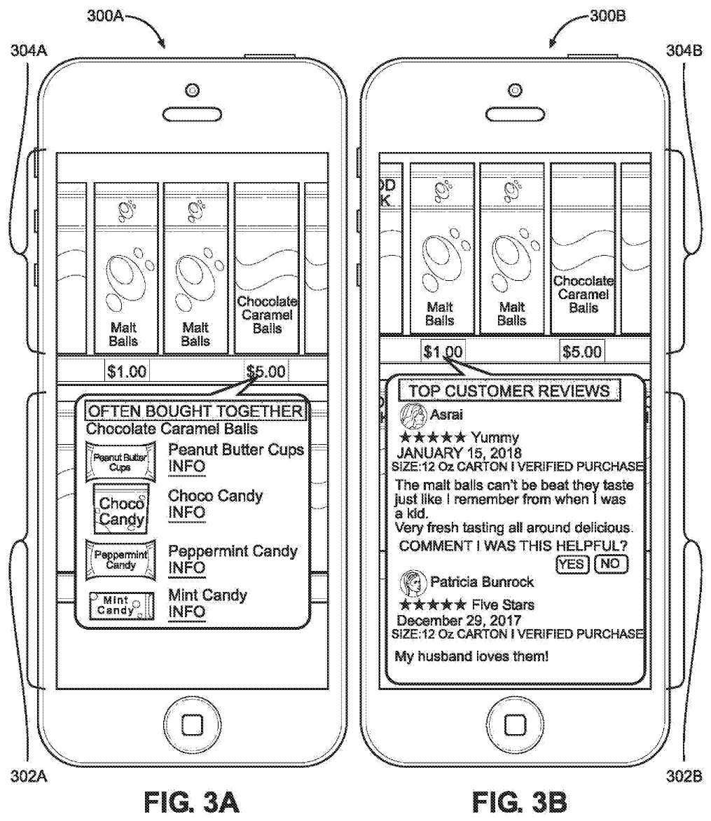

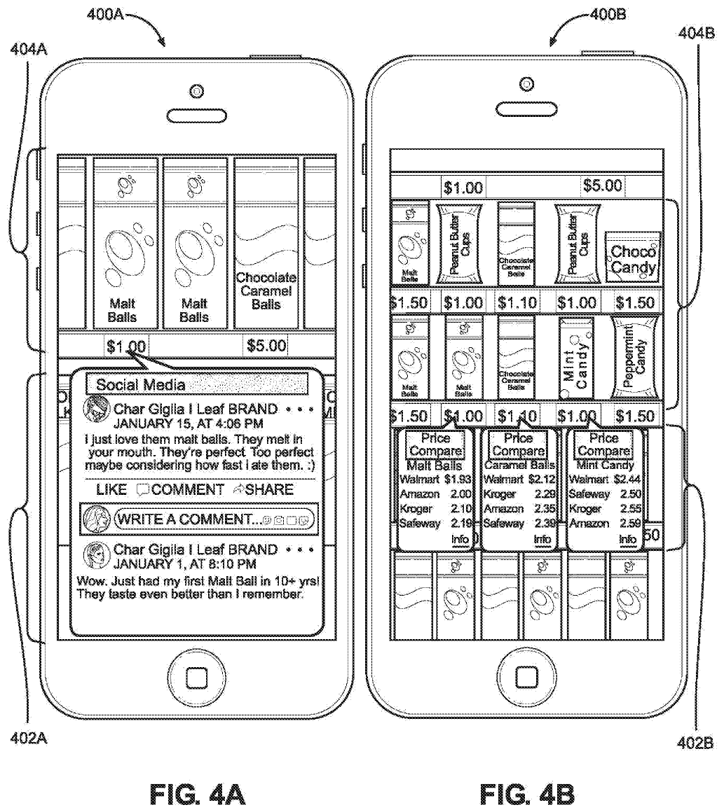

Turning briefly to FIGS. 3A, 3B, 4A and 4B, illustrated therein are additional examples of GUIs that may be output to a customer via a PDRO app on the customer device. Each of these figures illustrates a different type of supplemental information that may be output to a user via an offer graphic in accordance with embodiments described herein.

FIG. 3A illustrates a GUI 300A which includes an example offer graphic 302A. The offer graphic 302A comprises one type of supplemental information, which is suggestions for additional products that the customer should consider purchasing along with one of the products in the image 304A that was captured by the customer device. Such suggestions may be based on purchase history of the customer to whom the supplemental information is being output or other customers. In accordance with some embodiments, the supplemental information of offer graphic 302A comprises links that, if clicked on by the customer, will take the customer to additional information about the corresponding products (e.g., pricing or nutritional information).

FIG. 3B illustrates a GUI 300B which includes an example offer graphic 302B. Offer graphic 302B comprises another type of supplemental information, which is customer reviews of one of the products in the image 304B that was captured by the customer device. In accordance with some embodiments, the offer graphic 304A may allow the customer to provide input or selections, such as link to yet a different set of supplemental information.

FIG. 4A illustrates a GUI 400A which includes an example offer graphic 402A. Offer graphic 402A comprises another type of supplemental information, which is social media posts related to one of the products in the image 404A that was captured by the customer device. In the illustrated example, comments from a social media platform such as Twitter™, Facebook™ Instagram™, and the like, are shown.

FIG. 4B illustrates a GUI 400B which includes an example offer graphic 402B. Offer graphic 402B comprises another type of supplemental information, which is a price comparison information, for various retail establishments, for several of the products in the image 404B that was captured by the customer device.

In accordance with some embodiments, supplemental information that is shown to the customer may comprise information that has been retrieved by the PDRO server from third party sources of information. These may include social media websites, product review sites, transaction information from other retail establishments, etc. In such an embodiment, the system may sort and filter information such that the customer only sees information, posts, purchases, data, reviews, etc. made by accounts or people associated with the customer. For example, the information may be from persons who are linked to the customer on a third party social media website. In another example, the supplemental information may be determined to be from other customers who are determined to be similar to the customer in one or more ways (e.g., based on a comparison of customer profile information). For example, they may be of similar age, may live in a similar location, shop in the same retail establishment, be the same gender, etc.

In some embodiments, supplemental information may have been retrieved from data stored and catalogued for presentation within the PDRO System. For example, purchase history information may be queried to create information like price comparisons in other retail establishments or online retail portals. In another example, purchase history information may be used to determine products that are frequently purchased together. Again, these determinations may take into account information related to the customers in one or more ways, by referencing the customer's profile information. For example, the data may be sorted to show supplemental information from customers who may be of similar age, may live in a similar location, shop in the same retail establishment, be the same gender, etc.

Many types of supplemental information can be displayed to customers via the PDRO System, including, but not limited to the examples described herein. Other examples of supplemental information include:
(i) Price Comparisons—a customer may be provided with current prices for a product or similar product available at other retail establishments. In one embodiment, the retail establishments may prioritized or personalized to display only stores that the customer shops at. In another embodiment, the other prices may be displayed based on retail establishments that are related to the customer in some way, such as by proximity or by stores that the customer's peers frequently shop at.
(ii) Free Samples—supplemental information may comprise information about products in the retail establishment that are available as free samples. Free samples may be offered to that customer specifically or in one embodiment, the free products may be offered to all customers as “easter eggs” or in game-like fashion (like a scavenger hunt).
(iii) “Your List” digital retail offers—in one embodiment (e.g., if the customer allows the PDRO system to access his/her shopping list, or the PDRO app offers functionality for the customer to create a shopping list), supplemental information may comprise information or digital retail offers for items that are direct matches or directly competitive to the items on the shopping list.
(iv) Instant “Survey” Money—customers may be provided with an opportunity to earn instant discounts or other offers on certain products by providing information, opinion, etc. For example, the customer may be asked to answer a short survey on their customer device.
(v) Available Sizes/Flavors—supplemental information may comprise a helpful catalog-type feature, displaying all currently in-stock sizes, flavors, colors, multi-item packages, deluxe vs. basic, and other choices.
(vi) Add-an-Item Manufacturer Rebates—in some embodiments, customers may not get a manufacturer rebate offer on purchasing a single item, but an offering entity may offer a rebate if the customer agrees to a combined purchase with another product (e.g., from the same manufacturer or brand).
(vii) Your Purchase History—The system may provide the customer quick access to see items they've previously purchased at the retail establishment (e.g., within the last “x” years). In some embodiments, the supplemental information may inform the customer whether they've purchased a particular product before, and if so, when, how many, etc.
(viii) Quantity Discounts—customers can earn a manufacturer rebates on the purchase of more than one of the same item. Variable by T-Log data.
(ix) Subscription Savings—When customers agree to buy an item on an ongoing, periodic basis (e.g., at least once every 30 days), a manufacturer rebate or other discount may be applied to every purchase starting with the immediate purchase. Rebates or discounts can vary based on time commitment or quantities. The system tracks all future purchases and applies correct rebates on subsequent trips.
(x) Nutritional Charts—supplemental information may allow a customer to go beyond a food product's label to provide expanded information that can be customized for kids, seniors, people with specific health issues, or other factors and demographic categories.
(xi) Health Guidance—supplemental information may comprise health-related information on a given product; allergy warnings; health benefits or cautions (universal and by age/gender/health condition); and other data relevant to health. In one embodiment, this information can be customized by the customer for their specific health concerns.
(xii) Recipes with this Item—supplemental information may comprise types of popular recipes that use this product. In one embodiment, shoppers can scroll through recipes by category, serving sizes, popularity, cuisine type and value until they find one they like best.
(xiii) Financing Options—qualified customers who want to buy a specific item today, but prefer to pay over time, can see customized installment buying plans on a specific product, specifying the amount due today and the amount, number and duration of monthly payments. Ideal for creating the best possible financing choice for each individual customer's needs.
(xiv) Clearance Opportunities—clearance opportunities for products, which may be updated in real time based on quantities remaining and variable by T-Log data. Manufacturer rebates can be used or store-paid markdowns can be enabled.
(xv) Environmental Friendliness—Eco-conscious consumers often want to inform their buying decisions based on environmental factors; supplemental information may provide “green” ratings and/or detailed manufacturer-supplied data for specific products in terms of sustainability, contents, packaging, and more.
(xvi) Organic Information—information regarding non-use of hormones, pesticides, additives and GMOs as well as identifying grass-fed beef, free-range chickens, and similar products.

In accordance with some embodiments, the PDRO system tracks which digital retail offers have been output to a customer during a particular shopping visit, including an indication as to which product each offer was output for. Then, once the customer is ending his shipping visit by bringing his/her selected purchases to a POS to complete a transaction, the PDRO System may compare the products being purchased to the offers that had been displayed to the customer during the current visit (step 812). For example, the PDRO System may connect and communicate with the retail store's POS to ensure that any digital retail offers that were presented to the customer during the customer's current shopping visit are applied to the price of purchases at checkout if the customer is purchasing any products for which offers were output. This way, when the POS identifies products in the customer's current transaction that are associated with a digital retail offer that was presented to the customer, the price can be adjusted accordingly or another benefit, as defined by such offers, may otherwise be provided to the customer (step 814). Steps 812 and 814 may together be referred to as a reconciliation process herein (wherein the offers made to the customer are reconciled against the products being purchased by the customer and any relevant benefits are provided to the customer).

There are various ways in which the PDRO System may be able to identify when a customer is at a POS and in the process of checking out of a retail establishment. For example, the customer's device may establish a wired or wireless connection with the retail establishment's POS System and communicate (e.g., automatically or based on an input from the customer) information which allows the PDRO system to reconcile the customer's purchases with the digital retail offers that had been output to the customer during a current visit to the retail establishment. In another example, the customer may present an identifier at the POS (e.g., a bar code or QR code scannable at the POS), which identifies the customer and triggers the PDRO System to proceed to steps 812 and 814 or otherwise reconcile the customer's purchases with the digital retail offers that had been made to the customer during a current visit. For example, the PDRO app on the customer' device may generate or output such a code on a GUI of the customer device once the customer indicates that he/she is ready to check out. In yet another example, the customer device may present an identifier or code that can be used by the retail establishment POS system to determine the amount of discount to apply. In any of the foregoing, the identifier or code may be any of a serial number, alphanumeric code, a bar code, a QR code, or any other identifier that allows the PDRO System to confirm which digital retail offers had been output to the customer during a current visit to the retail establishment.

In some embodiments, the customer may use the customer device to make a purchase via the PDRO System. The customer may use the device to “scan” each product in the cart and pay via the customer device. Payment may be provided through any number of known digital payment means. The PDRO System may apply any benefits due the customer for offers that had been made to the customer when processing the transaction (e.g., prior to calculating the final amount due for the transaction). Once payment means has been provided, the PDRO System may present the customer with an identifier that can be used by staff at the retail establishment, or by the retail establishment's POS system to verify payment.

In one embodiment, rather than applying any benefits (e.g., discounts or rebates) to the transaction at the retail establishment and thus reducing the amount due for the transaction, the PDRO System may be operable to reconcile the products purchased (e.g., by receiving information regarding the transaction from the retail establishment) against the digital retail offers that had been output to the customer and provide the value of any benefits (e.g., sum of discount amounts) to a customer financial account associated with the customer (e.g., a credit to a credit card, a monetary amount available on a debit card, a number of points redeemable at partner sites, etc.).

In one embodiment, the reconciliation process may not happen while the customer is checking out at a POS of the retail establishment but may rather happen subsequent to the checkout transaction. For example, the customer may pay at the retail establishment's POS and then the PDRO reconciliation process may happen asynchronously or through the PDRO System at a time subsequent to checkout. A post-checkout reconciliation process may occur in various manners. For example, in one embodiment the customer may take a picture of each product purchased (in some embodiments the product may be required to be inside the shopping cart); the customer may then also be prompted to scan an identifier on a receipt from the retail establishment. Alternatively, the customer can take a picture of the receipt and optical recognition software may be used to compare the items on the receipt with the digital retail offers presented to the customer.

Applicant recognizes that there may be various potential ways in which a customer can attempt to attempt to defraud the PDRO system and provides here options for preventing or minimizing such fraud. For example, in one embodiment n order to be provided with a benefit of a digital retail offer, the customer may be required to provide biometric information, such as a fingerprint, voice command, facial recognition, etc. In another example, in one embodiment the PDRO System may be operable to run an audit of digital offers the benefits of which were provided to a given customer for a given transaction vs. the digital retail offers that were displayed to the customer during a shopping visit that culminated in the transaction and identify a potential fraud alert if there is a mismatch. In yet another example, in one embodiment the PDRO System may prompt the customer with one or more security questions prior to providing a benefit to the customer.

Although various embodiments have been described herein with reference to FIGS. 1A-8, Applicant recognizes that many variations and additional uses and embodiments may be implemented within the scope of the inventions so described.

For example, in one embodiment the PDRO System may be designed to identify information that would help improve the system, and to proactively collect that information from its users. For example, the system may be designed such that gaps in profiling information about customer or cohort behavior can be requested through a GUI of a PDRO app. This information may be used by the system to improve its intelligence by, for example, fine tuning when and to whom to present digital retail offers. In one embodiment, the PDRO System may attempt to collect statistically significant information about whether men between the age of 18 and 25 are willing to purchase prophylactics in a busy grocery store. Based on the responses, the system may begin to alter when to show digital retail offers to men of that age group, based on whether the store is busy or not. In another example, the information may be used by the system to improve the profile information it has about a particular customer, or about a particular cohort. For instance, the system may recognize that it does not have significant data about whether customers that purchase a particular brand of tomato sauce make that purchase a) because of the price, b) because they like the taste or c) because it is placed higher on the shelf. By polling the customers on the PDRO system, the system may be able to determine if digital retail offers for a competitive tomato sauce will be effective or not.

Polling or surveying of customers can be performed using a variety of methods. In one example, the customer may get a live voice or video call from a representative of the PDRO System. In another example the customer may receive a text message or a form with multiple choice question(s). In another example, the customer may be shown an interactive video, where the user is requested to provide input at the end. In another example, the user may be prompted to answer a poll or post a testimonial on a third party social media network. In one embodiment, the poll or survey may be designed such that they both collect information from the customer and provide information to the customer. In one embodiment, customers can be provided a benefit for providing information (e.g., a digital retail offer output to a customer may offer to provide a benefit to the customer in exchange for the customer's participation in a poll or survey).

In one embodiment, the PDRO system may be designed to be used by customers of online retailer portals or a combination of online retail portals and retailer establishment.

In accordance with some embodiments, if customers don't see a digital retail offer for a desired product, they can use the PDRO app to see if they can attract subsidies, discounts or rebate offers. For example, the customers could be prompted to point their customer device at a product and signal that they want to purchase that product. For example, the PDRO system app may be operable to open an automated dialog with the system, which may ask the customer to provide additional information, such as an explanation of why they want this product or what they plan to do with it. An insurance company, for example, or other entity may step up and fund a rebate on the item. Or, a charity or other third party could fund the entire cost of the purchase.

In accordance with some embodiments, a customer may not know the value of a benefit they will receive at the time of product selection or at checkout. In certain cases they are notified later. For example, in the case of a Deferred Social Network Rebate, an offer from a vendor could say: “Buy this and get 3 friends to try it and you get a rebate of X. Get 5 friends to try it and you get a rebate of Y.” In another example, a customer could agree to be reviewer and get paid according to the number of people who read their reviews and buy the product. A celebrity who buys and subsidizes a product could prompt 100k sales next month.

In accordance with some embodiments, the PDRO system app may enable a user (e.g., a blogger with a following), to enter into a “promotional contract” with an offering entity while shopping at the retail establishment. The consumer/blogger can ask, “If I buy these shoes, what will u give me if my followers buy 5,000 units? Or 100,000 units?” A manufacturer can also use the PDRO System to pay a celebrity or high-profile blogger for their initial endorsement and purchase on the spot.

In accordance with some embodiments, the PDRO System may enable new forms of money-back guarantees. One example is a Deferred Payment Money-Back Guarantee. For example, an offering entity can create an offer such as: “Buy this product, try it; we won't bill you for 2 weeks. If you are not happy, tell us and we don't charge you. If you like the product we charge until later or we defer payment until your next trip to the store.”

In accordance with some embodiments, the PDRO system can allow for persons to submit consumer reviews. For example, a consumer review could be a short video that the buyer shoots with their phone and uploads to an offering entity site, resulting in a clip that the offering entity can distribute for marketing purposes.

In accordance with some embodiments, the PDRO System may be used as a consulting platform to solicit expert reviews from other users of the PDRO app, and pay for the information and guidance received. While shopping at a retail establishment, a customer may be prompted to point their customer device at an item of interest and “ask the crowd” (not just your personal Social Media graph) for advice. For example, a customer might offer $2 to get a thorough review of why they should or should not spend $1,999 to buy a particular hi-def, big screen TV.

Some example illustrative examples of possible implementations of a PDRO System consistent with some embodiments described herein will now be described. The first example is from an offering entity perspective while the second example is from a customer perspective.

### Example 1: Offering Entity Perspective

Steve works in Brand Development at Champ™ brand footballs. Champ™ brand is just introducing their footballs to the market. One of the stores where Champ™ Brand will be sold is BigBox Sports stores, and they have a marketing platform called the PDRO System. Steve uses his computer's web browser to log into the Champ account on the PDRO System website. There he can access transaction information related to football sales at all BigBox Sports Store locations. While analyzing the data, he notices that the Minneapolis Minn. location sells the most footballs of any BigBox Sports location. They also sell 3 times more LacesOut brand footballs than any other brand that they sell. Wanting to capture some of the football sales market in that location, he decides to create a digital retail offer for customers of that store.

Steve clicks the button for “Create a Digital Retail Offer.” In the entry form, Steve selects the Minnesota location, and then answers the following criteria: a) the subsidy amount, and b) the group to be offered the subsidy. In the entry form for the subsidy amount, Steve passes over the standard options and chooses to enter his own price: $41.33. In the entry form for the group, he reviews his options and selects “All Customers.” Steve waits and hopes customers begin to take advantage of the offer.

Bob runs a big football team, who happens to be Tom's employer. Bob likes when his players shop at BigBox Sports stores, because he can use the PDRO System to provide incentives for his employees to buy the brands he prefers. In fact, he's even used the PDRO System to link his team's Offering Entity account to all of his player's shopping accounts so that he can subsidize purchases on products he prefers. Lately, Bob has been placing a big emphasis on the skill of catching a football. As a part of this emphasis, he decides he'll subsidize his team's purchases of equipment, as long as it's equipment that help them become better at catching. Bob uses his smart phone to access his team's account on the PDRO System and begins to browse the BigBox Sports product catalogue. He selects all catching-related products, seven products in total, which includes NeverDrop Gloves. Once selected, he selects “Add digital offer rule”. The PDRO System portal requests two criteria: a) the subsidy amount, and b) the group to be offered the subsidy. In the entry form for the subsidy amount, Bob reviews his options and selects “100% of all purchases.” In the entry form for the group, he reviews his options and selects “All Employees.” Bob waits and hopes his players take his advice and buy the gear he selected.

### Example 2: The Customer Perspective

Tom and Nick both go to the BigBox Sports store in Minneapolis Minn., in search of some items to purchase. Tom goes to the football accessories department to buy a pair of gloves for his upcoming game. On the shelf, Tom sees 3 different kinds of gloves: SureHand brand gloves, WeatherProtect brand gloves, and a super sticky model of gloves made by NeverDrop brand. Looking for a deal, Tom takes out his smartphone and opens the PDROS app. He points his phone's camera at the display shelf and looks at the phone's display screen, which displays a digital image of the display shelf. All of a sudden, a digital offer icon appears over the NeverDrop Brand Gloves that reads “Tom, choose these gloves and your employer will subsidize the price by 100%!” Tom rarely passes up the chance to save money, so he puts the NeverDrop Brand Gloves in his cart.

Next, Tom meets Nick at the section of the store that sells footballs. Nick is pointing his mobile phone's camera at the shelf of footballs, and using the PDROS app on his mobile phone to view an image of the display shelf holding 4 brands of footballs—LacesOut brand, Pigskin brand, RockHard brand, and Champ brand. Tom pulls out his mobile phone and does the same.

On Nick's screen, he sees all four brands of footballs, however two of them have digital offer icons overlaid onto the image. One icon appears over Pigskin Brand and says “Pigskin Sale —$52.00/ball.” Another icon appears over the Champ brand balls and says “New Product Release, try Champ brand for $41.33/ball.” Nick had never heard of Champ brand, but decides to give them a try to see if he likes them—he tosses 3 balls into his cart.

On Tom's screen, he sees all four brands of footballs too, however only one digital icon appears over the RockHard brand football. Tom's not very fond of RockHard footballs, and so happy with the deal he got on NeverDrop gloves, he decides only to purchase the gloves.

There's no line at the checkout aisle, but Nick decides to pay with the PDRO System app. Having already set up an account on the PDRO System app, complete with his credit card information, he taps “Checkout.” He's shown two options: “Pay with Phone” and “Pay cashier.” Nick selects to pay with phone, and uses his phone's camera to scan the barcode on each of the three footballs. The PDRO System app tally's the total, Nick confirms payment, and shows a digital payment receipt to the cashier on his way out.

Tom decides to pay at the cashier—he takes out his phone, taps “Checkout” in the PDRO System app, and then selects “Pay cashier”. His phone displays a QR code that the cashier scans. The POS System recognizes Tom's shopping session, and that he was offered a discount on the NeverDrop Gloves. The cashier scans the gloves, and Tom is awarded the 100% discount. Tom leaves happy with his new gloves.

In accordance with some embodiments, the PDRO system may use any number of known methods and sensors (e.g., put in place by the retail establishment and/or the PDRO system) to track a customer's location and/or shopping activity. For example, a retail establishment may be outfitted with networked devices that can track customers and activity, including, but not limited to one or more of the following (any or all of which may, in some embodiments, be accessed by the PDRO System, and be used to track any of the customer activity described herein): (i) a retail establishment's security system and/or cameras; (ii) sensors used to detect products inside the store, such as RFID readers and optical scanners; (iii) facial recognition and/or object recognition software; (iv) passive or active tracking beacons placed inside the retail establishment; (v) device location, such as wifi triangulation, cell triangulation, satellite triangulation, etc.; (vi) retail establishment shopping aides (e.g., a retail establishment may make devices and or software available to customers to enhance the shopping experience).

One example of a shopping aide is a smart cart (e.g., a shopping cart that is outfitted with computing and or sensor hardware and technology). In one embodiment a smart card may be operable to: (i) detect the products that are placed inside; (ii) connect to the PDRO System; (iii) communicate digital retail offers using output devices like screens or speakers; and/or (iv) transmit location information.

Another example of a shopping aide is a customer loyalty account or device, and or a software application accessed on a customer device. In accordance with some embodiments, a customer loyalty device may be used by the customer to: (i) scan products as they shop to check prices or find deals; (ii) track products selected for faster checkout; (iii) track the customer's location within the retail establishment; (iv) pay without using a traditional POS System, or to expedite payment with the POS System; (v) track purchases over time and accrue credits or discounts; (vi) create a wish list for future shopping trips and purchases; (vii) check products, prices, and offers available at another retail establishment; and/or (viii) purchase products from another retail establishment.

In one embodiment, the PDRO System may use data tracked by a customer device in order to track customer activity. In one embodiment, data tracked by the sensors and software on a customer's device may be collected by, or made available to, the PDRO System (e.g., based on permissions granted by the customer). For example, the PDRO System may access location data from GPS and other location data collected by a customer device. In another example, the PDRO System may access image data collected from a camera on a customer device. In yet another example, the PDRO System may access audio data collected by microphones of a customer device.

In one particular example embodiment, the PDRO System may detect the presence of wireless devices in a retail establishment, and establish connection with a customer device to communicate data regarding the customer's activity. For example, the PDRO System may access stored data on the customer device, such as search history, cookies and cached files, information stored in connected 3^{rd} party application accounts, etc.

In one embodiment, a customer may access the PDRO System using their customer device, and may provide active access to information related to shopping activity. For example, a PDRO System application on a customer's cell phone may give the customer access to a map of the store. The customer's progress through the store may be reflected on the map, as tracked through a connection with wireless devices inside the retail establishment. For example, a PDRO System app on a customer device may be used by the customer to track the products they place in their cart. These may be checked off of a list, or a camera of the customer device may be used to detect selected product identifiers. For example, a PDRO System may be used by a customer, as described above, to check information about a product, or to receive digital retail offers. During this process, the customer may use the device to indicate their intention of purchase, or acceptance of a digital retail offer. It should be noted that, in some embodiments, the customer purchasing a product corresponding to a digital retail offer that was displayed to the customer in association with the product may be deemed an acceptance of the offer (while in other embodiments a more affirmative acceptance of an offer may be required).

In accordance with some embodiments, the PDRO System may make assumptions and/or calculations to track, estimate, or predict activity and/or probabilities of behavior occurring, using any profile information the PDRO System has collected on a customer, or a customer's cohort. This practice may be used in lieu of using actual tracked customer data. Examples include, but are not limited to: (i) referencing the customer's shopping list on a customer account or device (e.g., a customer may identify products he or she intends to buy in advance using a software application on a customer's device, and then “check” them off as they shop); referencing past purchasing activity or profile information to predict activity (e.g., a customer may have purchased a particular brand of soft drink 10 out of the last 12 visits to a particular retail establishment). In some embodiments, the PDRO System may be operable to predict that the customer intends to buy that brand of soft drink on the customer's next visit to the retail establishment. For example, the PDRO System may recognize that a customer purchases at least $10 worth of fruit produce on every visit to a particular retail establishment. The PDRO System may predict that the customer intends to buy at least $10 worth of fruit on their next visit to that retail establishment. In another example, the PDRO System may recognize that a customer may consistently spend over $100 total per visit to a particular retail establishment. The PDRO System may predict that the customer is likely to spend close to that amount on their next visit to that retail establishment. In yet another example, the PDRO System may recognize that a customer spends over 15 minutes at all retail establishments in over 85% of visits. The PDRO System may predict that that a customer will spend over 15 minutes at a retail establishment on his or her a current shopping visit. In still another example, the PDRO System may recognize and predict that if a customer visits a particular department of a retail establishment in 80% of his or her visits, then he or she will likely visit that department of the retail establishment on his or her current shopping visit.

In accordance with some embodiments, the PDRO System may be operable to predict a customer's activity utilizing digital retail offers previously output to the customer (and, in some embodiments, accepted by the customer). For example, a customer may have been previously presented with 25 digital retail offers for clothing purchases made at a particular retail establishment and not accepted any of them or made any clothing purchases. The PRDO System may determine that the customer is not likely to buy clothing on their next visit. In another example, a customer may have previously accepted 75% of digital retail offers for prepared food. The PDRO System may predict that the customer is highly likely to purchase prepared food on their next visit.

In accordance with some embodiments, the PDRO System may predict a customer's activity at one retail establishment based on the customer's activity at another retail establishment. For example, if the PDRO System recognizes that a customer frequently purchases Brand X soft drinks at a first retail establishment, the PDRO System may predict that a customer is likely to purchase Brand X when visiting a similar, second retail establishment. Alternatively, the PDRO System may predict that a customer is likely to purchase Brand X at any retail establishment where it is available for sale. In another example, if the PDRO System recognizes that a customer spends less than 40 minutes at all retail establishments in over 90% of visits, then the PDRO System may predict that that a customer will not spend more than 40 minutes on a current shopping visit to a retail establishment. In yet another example, if the PDRO System recognizes that a customer only visits a particular department of a first retail establishment in fewer than 10% of his or her visits, then the PDRO System may predict that he or she will not visit a similar department in a second retail establishment.

It should be understood that the PDRO System may be operable to utilize any combination of the examples described herein to predict customer behavior. Further, in some embodiments behavior predictions and likelihood may be determined using mathematical modeling and algorithms that rely on PDRO System data and statistics to determine probabilities and models of behavior. In one embodiment, numerical scores may be applied to a customer's behavior, or the behavior of a customer's cohort. In such an embodiment, thresholds can be set by the PDRO System—if a customer's or customer cohort's scores exceed these thresholds, then a prediction may be set.

In one embodiment, the PDRO System and offering entities may make digital retail offers based on information collected about shopping activity prior to purchase. This might allow any offering entity to influence or change a customer's purchasing decisions. For example, the PDRO System may identify where in a retail establishment that the customer has visited and has not visited in one or more visits. A digital retail offer may be made to entice the customer to an area the customer has not visited. In another example, the PDRO System may identify a product that a customer has selected to purchase and then make suggestions and digital retail offers based on that product selection. In yet another example, the PDRO System may use predictions or profile information related to customer activity in order to determine appropriate suggestions and/or digital retail offers. In still another example, the PDRO System may try and influence customer activity, by offering conditional offers that require the customer to perform one or more activities in order to activate the offer (e.g., “Traveling around Washington today? Visit Jerry's Store and 10% off everything!” or “Not planning to get hot dogs this week? Well, if you pick some up today, you'll save $1.00 on every package you purchase.”).

In one embodiment, the PDRO System may use conditional and tracked customer activity to “gamify” the experience. This may allow offering entities to influence purchasing decisions and shopping behavior, while keeping it fun for the customer. A customer device might prompt the customer to perform activities that “unlock” discounts. Examples of such digital retail offers are provided below:
(i) “If you visit all 10 departments in the store today, you'll get an extra $10 off every $90 you spend.”
(ii) “Post 5 pictures of yourself modeling 5 new pieces of clothing on Twitter today, from an account connected to your PDRO System app. If you do, we'll take 25% off all purchases.”
(iii) “Post a picture of yourself in the soft drink aisle today—we'll select one photo.
(iv) “Use your PDRO System app today while shopping—if the first product you scan today is the “mystery product” you'll win a $100 gift card.”
(v) If you add 10 Nestle™ brand products to your cart in the next 10 minutes, you will be awarded 5 additional Nestle products for free.”

In one embodiment, a customer might use the PDRO System to connect with and interact with other people and or customers. Similarly, a customer's activity on a third party social media platform may be incorporated into the features of the PDRO System. For example, a customer may connect with people with whom the customer has an existing relationship, such as (i) friends, family and others who also have accounts on the PDRO System; (ii) contacts stored in a customer device or communication account; (iii) persons for whom email addresses are stored in a customer's email account; and/or (iv) contacts from a third party social networking platform. For example, the customer might be provided with functionality link an online social media account to the PDRO system by providing login credentials or giving permission for the system to access their account and information. It should be noted that contacts on a social networking platform may not be directly linked with each other on that platform. Rather, the term “Contact” in this context is used to describe any person who a customer might interact with on a social media platform.

In some embodiments, a customer may utilize the PDRO System to interact with people with whom the customer does not have an existing relationship with. For example, the PDRO system may determine that two or more customers have common profile traits and connect them, or suggest that they should connect. Any profile information collected by the PDRO System may be used to compare customers, and to determine commonalities. Some examples may include: (i) customers who shop at the same or similar retail establishments; (ii) customers who purchase similar products; (iii) customers of similar demographics, such as location, age, gender, etc.; and/or (iv) customers who belong to the same customer cohort, as described herein. In some embodiments, customer may be matched randomly or by trying to match people who have the least in common, or who do not share common traits.

In some embodiments, social interactions between customers might be facilitated and encouraged by the PDRO System. In such an embodiment, the PDRO System may incorporate these interactions into digital retail offers made by offering entities. For example, in one embodiment the customer interactivity may occur on the PDRO System. Customers may interact through any number of methods already employed by existing social media networking platforms. In another example, customer interactivity may occur on a third party platform.

Customer communications may be done, for example, via SMS or MIMS messaging on a mobile network, instant messages sent on a on a messaging platform, such as Facebook™ Messenger™, Apple™ Messenger™, What's App™, or Google™ Hangouts™. In one embodiment, communication may occur via text, image, and video posts and comments made to a social networking platform such as Twitter™, Facebook™, Instagram™, Snapchat™, etc. In one embodiment, customer may communicate with others via a cellular or internet voice and/or video call service, such as over a mobile network, Apple™ Facetime™, Skype™, etc.

### Rules of Interpretation

Numerous embodiments have been described, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention. Accordingly, those skilled in the art will recognize that the present invention may be practiced with various modifications and alterations. Although particular features of the present invention may be described with reference to one or more particular embodiments or figures that form a part of the present disclosure, and in which are shown, by way of illustration, specific embodiments of the invention, it should be understood that such features are not limited to usage in the one or more particular embodiments or figures with reference to which they are described. The present disclosure is thus neither a literal description of all embodiments of the invention nor a listing of features of the invention that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, TDMA, CDMA, and 3G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein.

Likewise, object methods or behaviors of a database can be used to implement the processes of the present invention. In addition, the databases may, in a known manner, be stored locally or remotely from a device that accesses data in such a database.

For example, as an example alternative to a database structure for storing information, a hierarchical electronic file folder structure may be used. A program may then be used to access the appropriate information in an appropriate file folder in the hierarchy based on a file path named in the program.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

While various embodiments have been described herein, it should be understood that the scope of the present invention is not limited to the particular embodiments explicitly described. Many other variations and embodiments would be understood by one of ordinary skill in the art upon reading the present description.

What is claimed is:

1. A method, comprising:
receiving, during a current shopping visit of a customer to a retail establishment and via an app stored on a mobile device of the customer, an image depicting a plurality of products located in a retail establishment at which the mobile device is located, the image also being output on a GUI of the mobile device;
analyzing the image to identify at least one of the products in the image based on at least one key data element within the image, thereby identifying a selected product;
retrieving customer profile information corresponding to the customer;
identifying at least one digital retail offer to output to the customer, based on the selected product and the customer profile information, the digital retail offer defining at least one benefit;
altering the image by superimposing an image graphic indicating the at least one digital retail offer, the image graphic being associated with the selected product in the image, thereby generating an altered image;
modifying the GUI modified image to output the altered image;
receiving an indication of a transaction being completed by the customer for the current shopping visit;
determining whether the selected product is part of the transaction; and
only if the selected product is part of the transaction, causing the benefit defined by the digital retail offer to be provided to the customer.

2. The method of claim 1, wherein causing the benefit defined by the digital retail offer to be provided to the customer comprises causing a POS to deduct a discount comprising the benefit from a transaction total of the transaction.

3. The method of claim 1, wherein causing the benefit defined by the digital retail offer to be provided to the customer comprises causing a monetary amount comprising the benefit to be added to a financial account of the customer.

4. The method of claim 3, wherein the benefit is provided to the customer after the transaction is completed.

5. The method of claim 1, further comprising:
generating a unique identifier to identify a shopping session comprising the current shopping visit to the retail establishment; and
outputting the unique identifier via a GUI via the app on the mobile device.

6. The method of claim 5, wherein receive an indication of a transaction being completed by the customer for the current shopping visit comprises receiving, from a computing device associated with the POS, the unique identifier.

7. The method of claim 1, wherein identifying the customer profile information comprises a time-based value calculated for the customer.

8. The method of claim 1, wherein modifying the GUI modified image to output the altered image comprises using Augmented Reality (AR) technology to modify the image.

9. The method of claim 1, wherein the image graphic indicating the digital retail offer includes an input mechanism via which the customer can interact with the digital retail offer.

10. The method of claim 1, further comprising:
storing in a memory an indication of each digital retail offer output to the customer during the current shopping visit to the retail establishment, thereby creating a record of digital retail offers made available to the customer for the transaction; and
accessing the record, after receiving the indication of the transaction, to identify which digital retail offers were output to the customer and thereby which benefits defined by such digital retail offers may be provided to the customer.

11. The method of claim 1, further comprising:
determining supplemental information corresponding to at least one of the image and the customer device; and
using the supplemental information to identify the at least one product.

12. The method of claim 11, wherein the supplemental information comprises an indication of an area of the retail establishment in which the image was taken.

13. A non-transitory computer-readable medium storing instructions for directing a processor of a computing device to perform a method, the method comprising:
receiving, during a current shopping visit of a customer to a retail establishment and via an app stored on a mobile device of the customer, an image depicting a plurality of products located in a retail establishment at which the mobile device is located, the image also being output on a GUI of the mobile device;
analyzing the image to identify at least one of the products in the image based on at least one key data element within the image, thereby identifying a selected product;
retrieving customer profile information corresponding to the customer;
identifying at least one digital retail offer to output to the customer, based on the selected product and the customer profile information, the digital retail offer defining at least one benefit;
altering the image by superimposing an image graphic indicating the at least one digital retail offer, the image graphic being associated with the selected product in the image, thereby generating an altered image;
modifying the GUI modified image to output the altered image;
receiving an indication of a transaction being completed by the customer for the current shopping visit;
determining whether the selected product is part of the transaction; and
only if the selected product is part of the transaction, causing the benefit defined by the digital retail offer to be provided to the customer.

14. The computer-readable medium of claim 13, wherein causing the benefit defined by the digital retail offer to be provided to the customer comprises causing a POS to deduct a discount comprising the benefit from a transaction total of the transaction.

15. The computer-readable medium of claim 13, wherein causing the benefit defined by the digital retail offer to be provided to the customer comprises causing a monetary amount comprising the benefit to be added to a financial account of the customer.

16. The computer-readable medium of claim 15, wherein the benefit is provided to the customer after the transaction is completed.

17. The computer-readable medium of claim 13, wherein the method further comprises:
generating a unique identifier to identify a shopping session comprising the current shopping visit to the retail establishment; and
outputting the unique identifier via a GUI via the app on the mobile device.

18. The computer-readable medium of claim 17, wherein receive an indication of a transaction being completed by the customer for the current shopping visit comprises receiving, from a computing device associated with the POS, the unique identifier.

19. The computer-readable medium of claim 13, wherein identifying the customer profile information comprises a time-based value calculated for the customer.

20. The computer-readable medium of claim 13, wherein modifying the GUI modified image to output the altered image comprises using Augmented Reality (AR) technology to modify the image.

21. The computer-readable of claim 13, wherein the image graphic indicating the digital retail offer includes an input mechanism via which the customer can interact with the digital retail offer.

22. The computer-readable medium of claim 13, wherein the method further comprises:
storing in a memory an indication of each digital retail offer output to the customer during the current shopping visit to the retail establishment, thereby creating a record of digital retail offers made available to the customer for the transaction; and
accessing the record, after receiving the indication of the transaction, to identify which digital retail offers were output to the customer and thereby which benefits defined by such digital retail offers may be provided to the customer.

23. The computer-readable medium of claim 13, wherein the method further comprises:
determining supplemental information corresponding to at least one of the image and the customer device; and
using the supplemental information to identify the at least one product.

24. The computer-readable medium of claim 13, wherein the supplemental information comprises an indication of an area of the retail establishment in which the image was taken.
